(19) United States
(12) Patent Application Publication
(10) Pub. No.: US 2024/0152756 A1
(43) Pub. Date: May 9, 2024

(54) STREAMLINED DEVELOPMENT AND DEPLOYMENT OF AUTOENCODERS

(71) Applicant: Intel Corporation, Santa Clara, CA (US)

(72) Inventors: Barath Lakshmanan, Chandler, AZ (US); Ashish B. Datta, Chandler, AZ (US); Craig D. Sperry, Chandler, AZ (US); David J. Austin, Phoenix, AZ (US); Caleb Mark McMillan, Forest Grove, OR (US); Neha Purushothaman, Phoenix, AZ (US); Rita H. Wouhaybi, Portland, OR (US)

(73) Assignee: Intel Corporation, Santa Clara, CA (US)

(21) Appl. No.: 18/548,805

(22) PCT Filed: Mar. 25, 2022
(86) PCT No.: PCT/US2022/022055

§ 371 Date: Sep. 1, 2023

Related U.S. Application Data
(60) Provisional application No. 63/166,993, filed on Mar. 27, 2021.

(51) Int. Cl. G06N 3/08

(52) U.S. Cl. CPC G06N 3/08

(57) ABSTRACT

In one embodiment, a method of training an autoencoder neural network includes determining autoencoder design parameters for the autoencoder neural network, including an input image size for an input image, a compression ratio for compression of the input image into a latent vector, and a latent vector size for the latent vector. The input image size is determined based on a resolution of training images and a size of target features to be detected. The compression ratio is determined based on entropy of the training images. The latent vector size is determined based on the compression ratio. The method further includes training the autoencoder neural network based on the autoencoder design parameters and the training dataset, and then saving the trained autoencoder neural network on a storage device.

### CROSS-REFERENCE TO RELATED APPLICATION

This patent application claims the benefit of the filing date of U.S. Provisional Patent Application Ser. No. 63/166,993, filed on Mar. 27, 2021, and entitled “STREAMLINED DEVELOPMENT AND DEPLOYMENT OF AUTOENCODERS,” the contents of which are hereby expressly incorporated by reference.

### FIELD OF THE SPECIFICATION

This disclosure relates in general to the field of artificial intelligence and machine learning, and more particularly, though not exclusively, to streamlined development and deployment of autoencoders.

### BACKGROUND

An autoencoder is a type of artificial neural network that can be used for a wide variety of use cases. Developing an autoencoder model can be very challenging, however, which is one of the primary hurdles preventing widespread adoption of autoencoders in real-world use cases. For example, choosing the optimal design for an autoencoder model is typically a highly manual trial-and-error process that requires numerous time-consuming iterations. Moreover, training an autoencoder model typically requires a large volume of training data to be manually collected and labeled, which is another tedious and time-consuming task. Further, updating an autoencoder model with new training data typically requires the model to be retrained from scratch.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example of an autoencoder neural network architecture.

FIG. 2 illustrates an example process flow for automated design and training of an optimal autoencoder neural network architecture.

FIG. 3 illustrates an examples process flow for training an unsupervised autoencoder neural network.

FIG. 4 an examples process flow for performing inference using an unsupervised autoencoder neural network.

FIG. 5 illustrates an example embodiment of an autoencoder neural network for anomaly detection.

FIG. 6 illustrates an example embodiment of an autoencoder neural network for anomaly detection using disentangled latent vectors.

FIG. 7 illustrates a flowchart for performing anomaly detection using a disentangled autoencoder neural network in accordance with certain embodiments.

FIG. 8 illustrates an example embodiment of an anomaly detection system for an industrial use case.

FIG. 9 illustrates an example embodiment of a computing device for implementing various use cases using autoencoder neural networks.

FIG. 10 illustrates an overview of an edge cloud configuration for edge computing.

FIG. 11 illustrates operational layers among endpoints, an edge cloud, and cloud computing environments.

FIG. 12 illustrates an example approach for networking and services in an edge computing system.

FIG. 13 illustrates a domain topology for respective internet-of-things (IoT) networks coupled through links to respective gateways, according to an example.

FIG. 14 illustrates a cloud computing network in communication with a mesh network of IoT devices operating as a fog device at the Edge of the cloud computing network, according to an example.

FIG. 15 illustrates a drawing of a cloud computing network, or cloud, in communication with a number of Internet of Things (IoT) devices, according to an example.

FIG. 16 illustrates a block diagram for an example IoT processing system architecture upon which any one or more of the techniques (e.g., operations, processes, methods, and methodologies) discussed herein may be performed, according to an example.

FIG. 17 illustrates an overview of layers of distributed compute deployed among an Edge computing system, according to an example.

FIG. 18 illustrates a compute and communication use case involving mobile access to applications in an Edge computing system.

FIG. 19 illustrates an example mobile Edge system reference architecture, arranged according to an ETSI Multi-Access Edge Computing (MEC) specification.

FIG. 20 illustrates an example MEC service architecture.

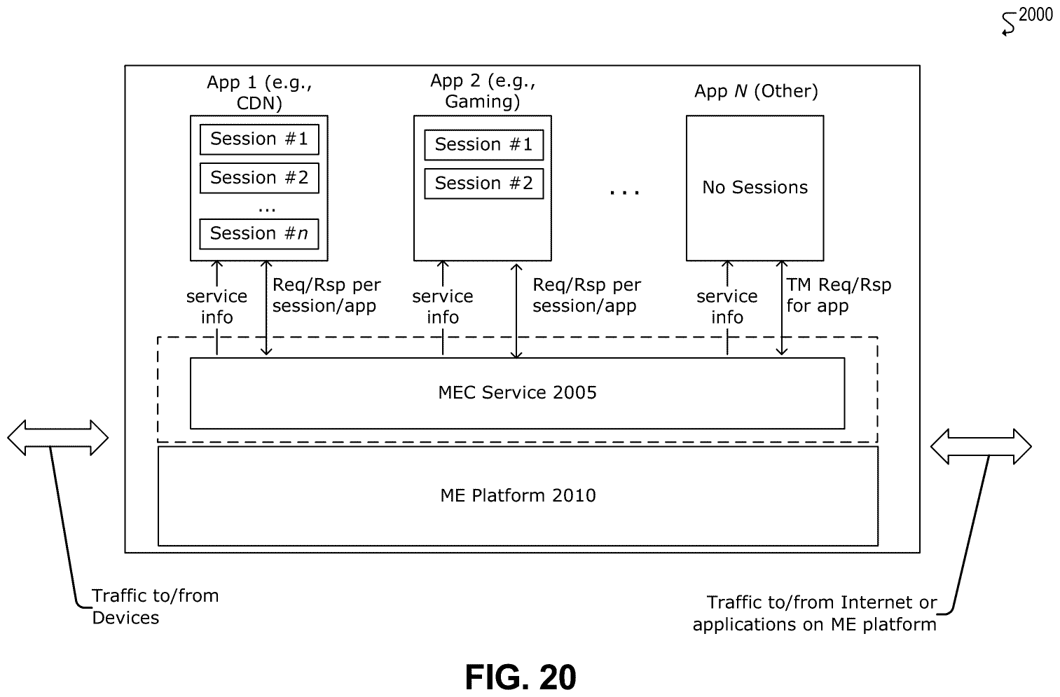

FIG. 21A provides an overview of example components for compute deployed at a compute node in an edge computing system.

FIG. 21B provides a further overview of example components within a computing device in an edge computing system.

FIG. 22 illustrates an example software distribution platform.

### EMBODIMENTS OF THE DISCLOSURE

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Streamlined Development and Deployment of Autoencoders

Autoencoder-based neural networks are a state-of-the-art deep learning technology that can be leveraged for a variety of use cases (e.g., particularly those with sparse datasets), including anomaly detection, segmentation, style transfer, and so forth. For example, an autoencoder is a type of neural network that learns to efficiently encode or compress data by recognizing patterns in the data and learning to ignore insignificant portions of the data (referred to as “noise”). The encoding can be validated and refined by attempting to regenerate the original data from the encoded data. For example, an autoencoder typically includes an encoder that learns to encode the input data into an encoded representation, and a decoder that learns to decode the encoded representation back into the original input.

The primary hurdle preventing widespread adoption of these models in real-life industrial applications is the highly challenging development process, which often requires expert-level knowledge to solve. Achieving the best performance requires making design choices that are optimal to the specific dataset in a given use case, selecting the right hyperparameter values to achieve training convergence, and training the network using a high-quality training dataset (e.g., with numerous data samples that are sufficiently diverse and accurately labeled). Often, the entire development process must be repeated or extended with secondary solution/models for sub-tasks such as classification or segmentation.

For example, there are several design choices that needs to be made to design and train an autoencoder model and to obtain the optimal set of parameters for a given dataset. Most of the design choices made by data scientists or domain experts are selected based on some combination of intuition and trial-and-error methods. Other design parameters may seem trivial, but careful consideration of these parameters often yields better results. However, designing and tuning an autoencoder network is an iterative process that requires not only adjustments to hyperparameter values, but also changes to the model architecture that are correlated with the dataset in use. Autoencoder models are notoriously hard to converge, and as a result, the iterative tuning process is often painstakingly prolonged.

Autoencoders also require labor-intensive and expensive manual data labeling (supervised and semi-supervised). For every new label class addition, the entire system needs to be retrained.

Variational autoencoders (VAEs) are a type of autoencoder that explore the variation of the dataset in use by allowing the latent vector space to be regularized such that it is possible to create a uniform mapping between the input data space and the compressed latent vector space. VAEs require the sub-tasks to be associated with the latent vector space during the initial training of model. Any new sub-task requires the entire model to be retrained.

In this disclosure, a set of design methodologies and principles is presented to design an autoencoder network (e.g., for anomaly detection) that overcomes and automates the aforementioned barriers regarding development and scale. These techniques make the development process automated and scalable for different anomaly detection applications, with very minimal to no human interaction in the loop.

For example, to automate hyperparameter and network architecture selection, a two-stage parameter estimation process is presented: (1) first, the optimal network architecture and parameters are estimated, and (2) those parameters are then fine tuned to achieve the required accuracy and performance targets.

As another example, to minimize the need for retraining the entire model for every new variation in the input data, a method to encode the input data and decode only necessary/required portion of the input is presented. The low-dimensional latent vector is disentangled to have a predetermined format. This allows for the full-size decoder to be split into multiple smaller task specific decoders that can be individually trained to account for non-anomalous variations.

Further, to address problems relating to collecting an optimal training dataset (e.g., manual data labeling, data imbalance, label scarcity), a new unsupervised anomaly detection framework is presented, which includes a training and inference module that enables the system to be directly deployed online.

Traditional methods, such as neural architecture search (NAS) or manually training and choosing the best design decisions, are computationally very expensive and time consuming. The methodologies presented in this disclosure improve accuracy of localization and recall rate for semi-supervised anomaly detection with minimal human interaction.

The approaches described in this disclosure are also highly scalable, which makes it easier to apply artificial intelligence (AI) algorithms to real-world business use cases. There are significant challenges in hiring a data science team to build an AI application for automating factory procedures, such as the cost of the resources involved, data sharing agreements in place for transferring highly-sensitive and/or proprietary data, knowledge transfer on factory procedures, periodic maintenance support from the data science team, and so forth. The approaches described in this disclosure allow factories to create custom deep networks for several applications, such as defect detection and quality inspection, with minimal deep learning knowledge in a very efficient manner.

These approaches also provide a rapid AI model solution with low-bandwidth analytics. For example, since the required retraining can be contained to only the individual decoder affected by the change in input space, the required bandwidth and computation can be significantly reduced. With this technology, entities can architect and implement complex autoencoder model-based applications and decrease the time to market for their use cases.

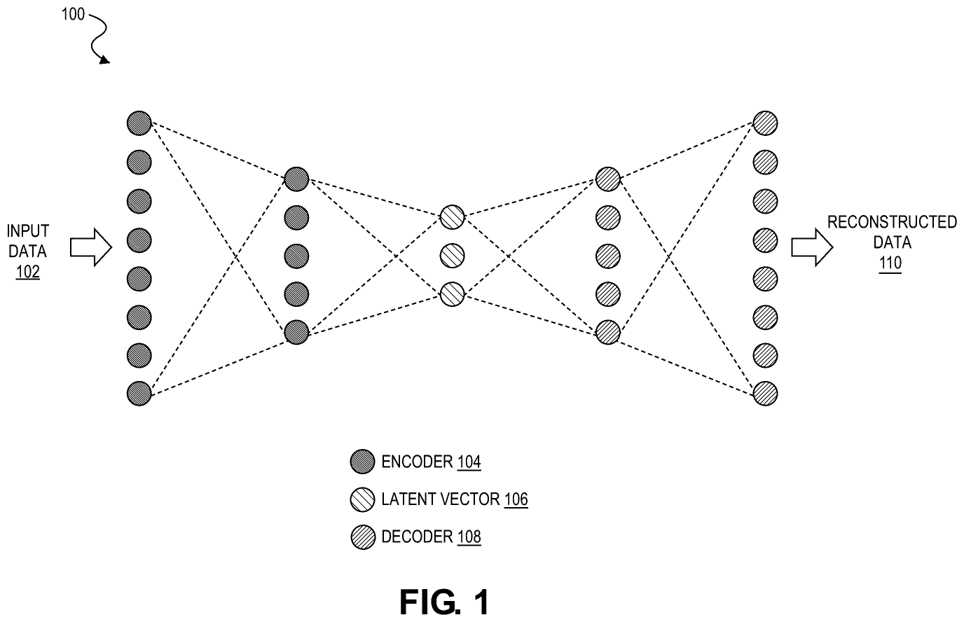

FIG. 1 illustrates an example of an autoencoder neural network architecture 100. An autoencoder is a type of neural network that recognizes patterns in data and learns to efficiently encode or compress the data either in supervised or unsupervised manner. For example, the autoencoder network accepts input data 102 such as an image, compresses the input data 102 into a latent representation 106 (also referred to as a latent vector) that keeps the structural information of the data intact, and then reconstructs the data 110 back to the input image dimension. The ability of the autoencoder to compress data to a lower-dimensional latent representation is the key to capture any defects for anomaly detection. The encoder portion 104 of the autoencoder network 100 performs the compression/encoding of the input data 102 (e.g., image) into the latent vector representation 106, and the decoder portion 108 takes the compressed latent vector 106 and reconstructs it back into the original data 110 (e.g., image) as closely as possible.

The design and training of an autoencoder network involves careful selection and tuning of parameters, such as input image size, latent vector size, encoder architecture, decoder architecture, and so forth. The performance of the network greatly depends on the choice of these parameters as well as the dependencies across them. It is also notoriously difficult to design an autoencoder network that converges during training, and even if it does converge, it often takes days or weeks (if not longer) to complete.

Accordingly, this disclosure presents various techniques that can be used— either separately or together—to automate the choice of the aforementioned parameters and train a scalable autoencoder solution with minimal data and no labels. In particular, these techniques include (1) dynamic selection of an optimal autoencoder network architecture, (2) unsupervised autoencoder learning based on detection of latent space outliers, and (3) disentangled autoencoder latent vector representation for task-specific decoding, which are described in further detail throughout the following sections.

### Dynamic Selection of Optimal Autoencoder Network Architectures

Developing an autoencoder network architecture that fits the underlying dataset is time consuming and notoriously hard to converge. In particular, designing and tuning autoencoder network is an iterative process, which takes significant time and compute resources to converge. There are several design choices that need to be made to design and train the autoencoder model with the optimal set of parameters for a given dataset. Most of these design choices are typically selected based on trial-and-error methods. Moreover, other design parameters may seem trivial, but careful consideration of those parameters often yields better results.

Accordingly, this section presents a solution for dynamically selecting an optimal network architecture and associated hyperparameters for the design of an autoencoder (e.g., based on properties of underlying dataset and target labels). In this manner, the network schema and associated hyperparameters can be autotuned very quickly.

In this solution, for example, an autoencoder network is designed (e.g., for anomaly detection) using a two-stage process: (1) first, the optimal network architecture and parameters are estimated using an iterative algorithm based on properties of the data and the target performance requirements; and (2) next, the parameters are fine-tuned using automated machine learning (AutoML) methods to achieve the required accuracy and performance targets.

Various methods associated with identifying different key features of the network architecture are also presented, although other methods achieving similar results can also be used as part of the described solution.

This solution provides numerous advantages. For example, the solution is highly scalable and enables deep networks to be trained for a variety of applications (e.g., defect detection, quality inspection). Moreover, while traditional methods are very computationally expensive and time consuming to develop, the described solution enables autoencoder networks to be developed quickly without any human intervention. Thus, with this technology, entities can architect and implement complex autoencoder models while decreasing the time to market for their use cases.

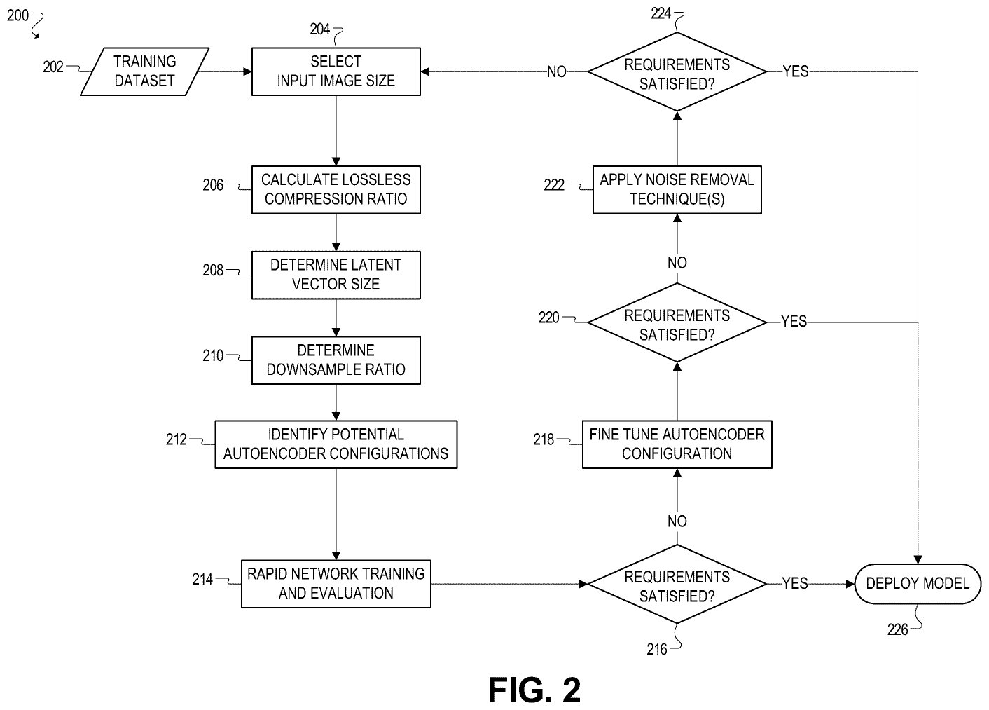

FIG. 2 illustrates an example process flow 200 for automated design and training of an optimal autoencoder neural network architecture. For example, the design and training of the autoencoder network involves careful selection and tuning of parameters, such as input image size, latent vector size, encoder architecture, decoder architecture, and so forth. The performance of the autoencoder network greatly depends on the choice of these parameters as well as the dependencies across them. It is notoriously difficult to find a design that causes the autoencoder network to converge during training, and even if it does converge, it often takes days or weeks (if not longer) to complete. Accordingly, in the illustrated example, process flow 200 can be performed to automatically select the optimal parameters for an autoencoder architecture and fine tune them to achieve the best results.

First, image(s) in the training dataset 202 are used to select the optimal size of the input image for the autoencoder network (block 204). In particular, the input image size for the autoencoder network may be calculated based on the resolution of representative image(s) in the training dataset and the size/resolution of the target features of interest that the autoencoder needs to detect. For example, for anomaly detection, the input image size is determined based on the training image resolution and the size/resolution of the smallest and largest defects that need to be detected (e.g., based on the bounding boxes of labeled defects in the training images). In particular, the size of the input image should be proportional to the size of the defect(s) or feature(s) under consideration. In some embodiments, if the original images that will be processed by the autoencoder network (e.g., during training or inference) are significantly larger than the relevant defects or features of interest, the images may be patched into smaller regions, either randomly or using a predefined pattern, to improve the accuracy/performance of the network. For example, the autoencoder network can be configured with an input image size smaller than the original images but proportional to the defect/feature size, and the original images can be partitioned into smaller patches, where each patch serves as an input image processed by the autoencoder network.

A compression ratio is then calculated for the representative image (or set of images patches) (block 206). The compression ratio may refer to any measurement of the relative reduction in size of a compressed representation of data (e.g., the reduction in size of the input image to the latent vector). The compression ratio may be calculated based on the entropy of the image, quantization parameter (QP) algorithms, or any other similar approach based on properties of the image. Entropy may refer to any measure of the information content represented in an image (e.g., an image with a detailed foreground may have a higher entropy value than a background image). For example, algorithms used to select initial QP values can be used to compute an estimate of an optimal compression ratio, and rate control algorithms can be used for updating QP values during encoding to find the optimum compression ratio based on initial training results.

To determine the compression ratio based on QP values, each image in the training dataset should be passed through a rate control algorithm to determine its QP value. There are many rate control algorithms available, and their effectiveness often depends on image content, so a rate control algorithm may be chosen based on its effectiveness on the particular content in the training images. The compression ratio can then be computed based on the average QP value for the images within a given training dataset.

In some embodiments, for example, the optimal compression ratio for the autoencoder network is calculated using the QP select algorithm based on the following equations:

$${BestInitial}_{QP} = {arg min}_{{Initial}_{QP = 0 , … , 51}} ( \frac{1}{{NPSNR}_{{Initial}_{QP}}} + {NBIT}_{{Initial}_{QP}} + {NDQP}_{{Initial}_{QP}} )$$

$${NPSNR}_{{Initial}_{QP}} = \frac{{PSNR}_{{Initial}_{QP}} - {min}_{{Initial}_{QP = 0 , … , 51}} ( {PSNR}_{{Initial}_{QP}} )}{{max}_{{Initial}_{QP = 0 , … , 51}} ( {PSNR}_{{Initial}_{QP}} ) - {min}_{{Initial}_{QP = 0 , … , 51}} ( {PSNR}_{{Initial}_{QP}} )} , {Initial}_{QP} = 0 , … , 51 \\ {NBIT}_{{Initial}_{QP}} = \frac{{BIT}_{{Initial}_{QP}} - {min}_{{Initial}_{QP = 0 , … , 51}} ( {BIT}_{{Initial}_{QP}} )}{{max}_{{Initial}_{QP = 0 , … , 51}} ( {BIT}_{{Initial}_{QP}} ) - {min}_{{Initial}_{QP = 0 , … , 51}} ( {BIT}_{{Initial}_{QP}} )} , {Initial}_{QP} = 0 , … , 51 \\ {NDQP}_{{Initial}_{QP}} = \frac{{DQP}_{{Initial}_{QP}} - {min}_{{Initial}_{QP = 0 , … , 51}} ( {DQP}_{{Initial}_{QP}} )}{{max}_{{Initial}_{QP = 0 , … , 51}} ( {DQP}_{{Initial}_{QP}} ) - {min}_{{Initial}_{QP = 0 , … , 51}} ( {DQP}_{{Initial}_{QP}} )} , {Initial}_{QP} = 0 , … , 51$$

In these equations, the NPSNR, NBIT, and NDQP values are the normalized peak signal-to-noise ratio (PSNR), bit rate, and QP value differences for a set of training images (e.g., 60 images). The best initial QP value is the value that determines the optimal compression ratio.

Based on the compression ratio along the x, y, and z axis, the size of the latent vector is determined (e.g., the number of dimensions and the size of each dimension) (block 208). With the latent vector size/dimensions, the downsample ratio (block 210) is calculated. For example, when the input image is processed through the autoencoder network, the image is downsized by certain layers of the neural network architecture, such as pooling layer(s) and/or convolution layer(s) with large strides. Based on the estimated latent vector dimensions, the number of downsampling layers are stacked within the network until the input image reaches the downsampled size (e.g., which is the same as the latent vector size).

With the calculated input image size and latent vector, different possible architecture configurations are identified and prioritized for training and testing (block 212). For example, the potential architecture configurations may include the type of neural network architecture used to implement the encoder or decoder (e.g., a convolutional neural network (CNN) architecture based on ResNet, MobileNet, EfficientNet, etc.) and various design parameters, such as the number of layers, layer type (e.g., pooling, convolutional, etc.), the width, height, and depth (e.g., channels) of each layer, the layer order and connectivity (e.g., order in which the layers are stacked and/or connected), and so forth.

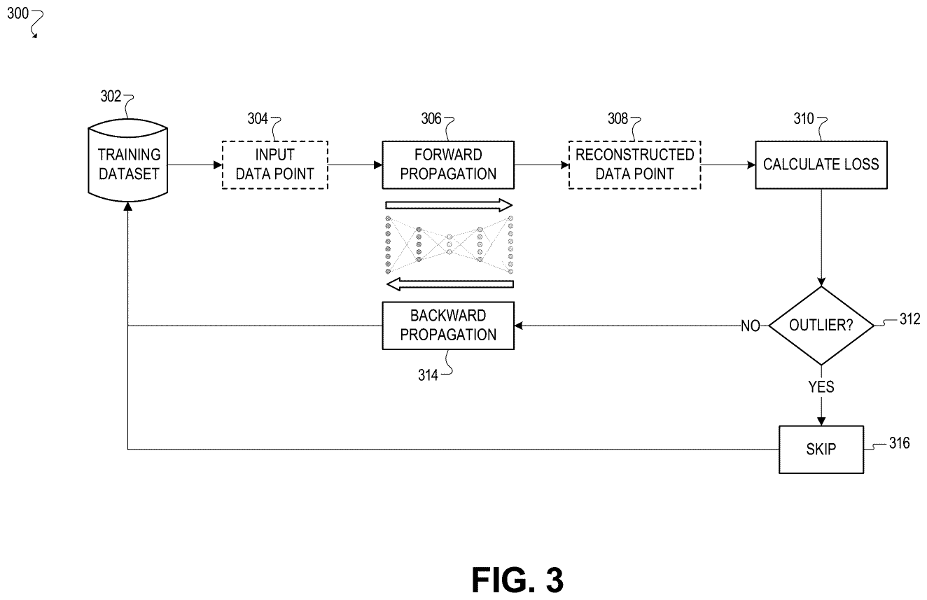

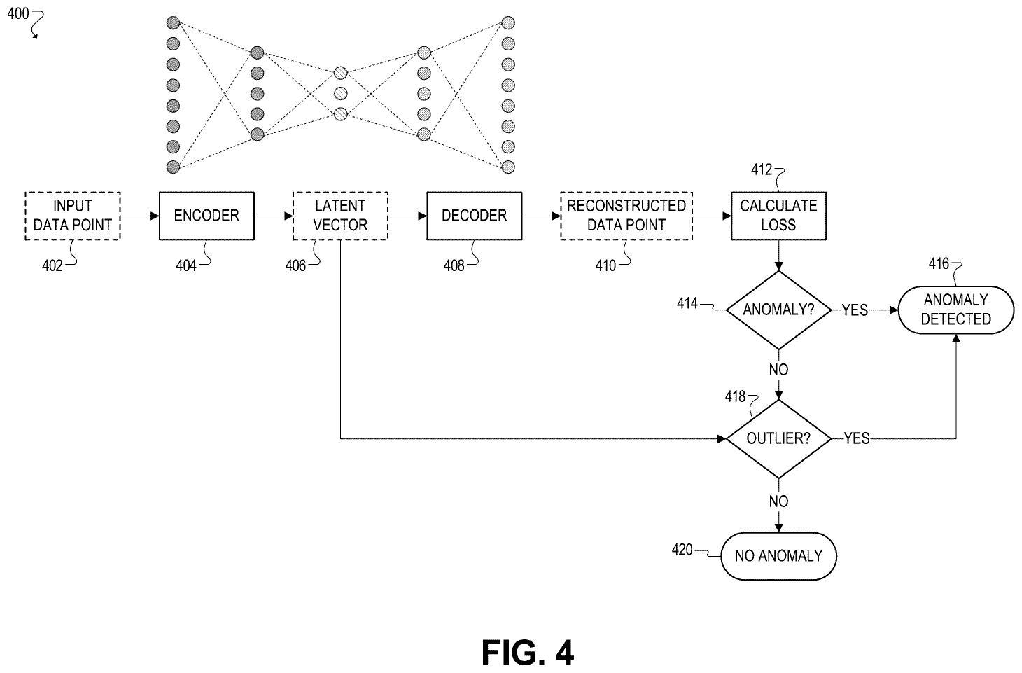

Rapid network training is then performed on each of the identified network configurations (block 214). For example, the architecture configuration is coarsely selected at this stage, which enables the search space to be narrowed and thus reduces training time. Out of all the configurations, the network with the best performance (e.g., accuracy, speed) is selected and trained further until the convergence/performance criteria is met. In some embodiments, for example, the training may be performed using the unsupervised learning approach described in connection with FIGS. 3 and 4 of this disclosure.

If the network satisfies the performance requirements (block 216), training is complete and the model is deployed (block 226). If the network does not satisfy the performance requirements, some of the parameters are fine-tuned using automated machine learning (AutoML) techniques but at a more granular level to obtain better results (block 218), and the autoencoder network is retrained based on the adjusted configuration. In particular, the parameters are fine-tuned using AutoML methods to achieve the required accuracy and performance targets. Moreover, in some embodiments, AutoML may also be leveraged to orchestrate the different training computations on different devices to optimize time and bring back the results for the decision points to the orchestrator.

If the network satisfies the performance requirements after being fine-tuned (block 220), the model may be deployed (block 226), and/or additional techniques may be applied to further increase performance (block 222), such as additive noise removal (e.g., removing noise/artifacts to make small features or defects—such as speckle—stand out more), image imputation (e.g., supplying missing image data to enhance the image quality or resolution), coarse dropout (e.g., to train the network on noise and eliminate false positives), and so forth. If the results are still far from the performance targets (block 224), the entire process may be repeated using a different input image size that is within the exploration space.

This solution can also be extended to other types of neural networks beyond autoencoders, as well as other types of properties and parameters beyond image size and compression ratio, such as image histograms or any other relevant features for a particular autoencoder use case.

### Unsupervised Autoencoder Learning Based on Detection of Latent Space Outliers

Autoencoders used for anomaly detection and other similar use cases are primarily implemented using supervised learning. Some recent advancements have also started paving the way for semi-supervised anomaly detection, where the system learns only from good data samples. However, supervised and semi-supervised methods require a significant volume of training data to be manually labeled, as they cannot be used on data with no labels. Moreover, early research on unsupervised learning using autoencoders is not applicable to datasets with a high imbalance of data, which are commonly found in use cases such as anomaly detection.

Accordingly, this section presents an unsupervised autoencoder capable of performing anomaly detection and other similar use cases in an unsupervised manner, which can be directly deployed as an online learning system in any deployment environment (e.g., industrial settings, etc.). In particular, the autoencoder uses a new unsupervised framework to perform training and inference based on the detection of outliers in the latent space, which enables the system to be deployed directly online.

This solution provides numerous advantages. For example, the solution eliminates the need to manually label data for system training, which is a very time consuming and expensive process. Moreover, in real-world systems, the number of defects that occur is relatively small, which makes it challenging to capture every type of potential defect prior to training the model. The training and inference system disclosed herein addresses this issue and is capable of handling a very high data imbalance.

The system includes training and inference modules that can be used to perform unsupervised anomaly detection for a given problem or use case. In some embodiments, for example, if the available training data is not labeled, the model development process (e.g., the automated autoencoder parameter selection described in previous section) can be supplemented with a training and inference module based on entropy estimation to perform unsupervised anomaly detection.

FIG. 3 illustrates an examples process flow 300 for training an unsupervised autoencoder neural network. In particular, process flow 300 may be used to train an autoencoder in an unsupervised fashion—without relying on manually-labelled training data—to perform anomaly detection or another similar use case. In some embodiments, process flow 300 may be used to perform the training steps in the automated autoencoder development process of FIG. 2.

For example, in order for the network to converge quickly and reach the global minima during training, process flow 300 leverages a selective training method. In particular, based on the entropy of the image or the reconstruction loss, each data point 304 (e.g., image) in the training dataset 302 is evaluated to determine if it belongs to the same category of data within a batch or mini-batch, and only the data having similar loss is used in the backward pass for weight adjustments. Any outlier will be skipped for training (e.g., backward propagation/weight adjustment) during that particular epoch but may be used in future epochs if deemed to be an inlier.

For example, in process flow 300, each input data point 304 (e.g., image) in the training dataset 302 is forward propagated 306 through an autoencoder network architecture, which transforms the data point 304 into a latent vector and then reconstructs the latent vector back into a reconstructed data point 308 (e.g., as described throughout this disclosure).

The reconstruction loss is then calculated 310 for the reconstructed data point 308 (e.g., based on the loss in quality/entropy of the reconstructed data point 308 relative to the original data point 304) and is used to determine whether the data point is an inlier or outlier 312. For example, if the reconstruction loss is similar to that of other data points in a batch or mini-batch of training samples (e.g., based on any similarity/difference calculation or clustering algorithm), the data point 304 is considered an inlier and is backward propagated 314 through the autoencoder network architecture to perform weight adjustments to train the network. Alternatively, if the reconstruction loss is dissimilar to that of the other data points, the data point 304 is deemed an outlier and is skipped 316 for purposes of backward propagation and weight adjustments. The weights may refer to numerical values associated with nodes (neurons) in an artificial neural network, which may indicate the importance or influence of a particular node or feature in computing the output of the neural network.

FIG. 4 illustrates an examples process flow 400 for performing inference using an unsupervised autoencoder neural network. In some embodiments, for example, process flow 400 may be used to perform inference on input data using a trained autoencoder network to detect anomalies or infer other information from the input data.

For example, after training an unsupervised autoencoder network using the process flow of FIG. 3, the reconstruction error may be minimal for the majority of the samples. Depending on the network architecture, the autoencoder network might end up reconstructing defective samples with low reconstruction loss as well, thus resulting in false negatives (e.g., failing to detect the defects/anomalies). To make the system more accurate and robust, a secondary outlier detection system is trained based on the data from the latent space. The dimensionality of the data might be further reduced with techniques such as principal component analysis (PCA) before performing the outlier detection. Any new data with a different distribution will stand out from the rest of the input data. The difference in distribution will be efficiently captured in the latent space (or its PCA) and will be detected by the outlier detection module.

For example, in process flow 400, inference is performed on an unlabeled data point (e.g., an image captured by a camera/sensor) using an unsupervised autoencoder network (e.g., trained using the process flow of FIG. 3). For example, the encoder portion 404 of the autoencoder network transforms the data point 402 into a latent vector 406, and the decoder portion 408 of the network then reconstructs the latent vector 406 back into a reconstructed data point 410 (e.g., as described throughout this disclosure).

The reconstruction loss is then calculated 412 for the reconstructed data point 410 (e.g., based on the loss in quality/entropy of the reconstructed data point 410 relative to the original data point 402), which is used to infer whether the data point 402 is an anomaly/defect 414. For example, if the reconstruction loss is high, the data point 402 may be classified as an anomaly or defect 416. If the reconstruction loss is low, the data point 402 is likely non-anomalous, although it could potentially be a false negative (e.g., anomalous/defective despite the low reconstruction loss). As a result, an outlier detection module 418 is used to determine whether the data point 402 is a false negative (e.g., an anomalous outlier).

In some embodiments, for example, the outlier detection module 418 is trained to detect anomalous outliers based on the distribution of data in the latent vector space of the training data points (e.g., training images). For example, if the latent vector 406 for the current data point 402 has a different data distribution relative to the latent vector space of the training dataset (e.g., based on standard deviation, clustering, and/or distance calculations), then the current data point 402 may be treated as an outlier, or a false negative, and thus classified as an anomaly 416. However, if the latent vector 406 for the current point 402 has a similar data distribution as the latent vectors for the training data, the current point 402 may be classified as normal or non-anomalous 420.

### Disentangled Autoencoder Latent Vector Representation for Task-Specific Decoding

As discussed above, autoencoders are a frequently used neural network architecture for anomaly detection and a variety of other use cases, which are implemented using an encoder, a low-dimensional latent vector representation of the input data, and a decoder. The input data points are compressed into low-dimensional latent vector representations that keep the structural information of the data intact, which are then decoded—either with an autoencoder architecture or any other type of neural network architecture—to generate new meaningful data.

Vanilla autoencoders can be used for anomaly detection use cases. Moreover, even though variational autoencoders (VAEs) allow for the latent vector space to be regularized such that it is possible to create a uniform mapping between the input data space and the compressed latent vector space, the model weights are trained based on the overall loss functions between the input and output. Thus, for both types of autoencoders, when there is a “normal” variation in the input data space that was not accounted for during the initial training phase, the model has to be fully retrained from scratch to prevent the variation from being misclassified as anomalous. This can be computationally expensive and time consuming.

Accordingly, this disclosure presents a solution that separates the features of input data points and then compresses the unraveled feature set into a latent vector representation such that it can be segmented into task-specific vectors, which can then be decoded using task-specific decoders. In this manner, the solution allows for task-based retraining of an autoencoder network (e.g., for use cases such as anomaly/defect detection), which significantly reduces the computational complexity and time required to retrain the network compared to the current blanket retraining approach, which requires the network to be completely retrained from scratch whenever the input data space is modified in any way.

For example, the system encodes the input data and decodes only the necessary/required portion of the input by disentangling the low-dimensional latent vector to have a predetermined format, which allows the full-size decoder to be split into multiple smaller task-specific decoders that can be individually trained to account for non-anomalous variations. The underlying concept is that the weights that account for one task, such as the geometrical shape of an object in an image, are not affected by the new weights that are learned for a new task, such as a change in the color of the object.

This solution provides numerous advantages. This method enables rapid AI training and low-bandwidth analytics since the requisite retraining can be exclusively limited to the individual decoder affected by the change in input space, which significantly reduces the required computation. This helps ensure that the weights learned for a particular task are not affected by the retraining required for another different task. Further, if the data ingestion point is on a remote edge device, only the disentangled latent vector needs to be transferred over the network to the training system to retrain the task-specific decoder, hence reducing the bandwidth requirements for the data pipeline.

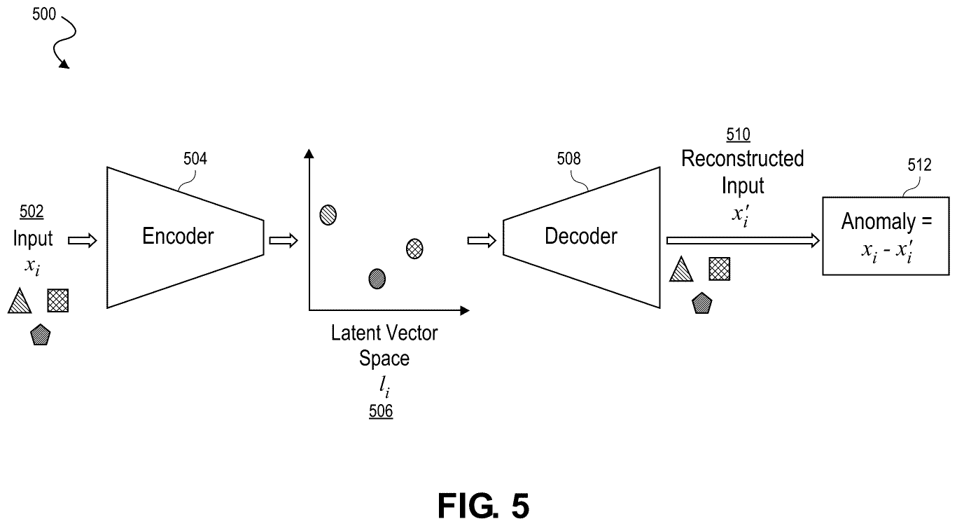

FIG. 5 illustrates an example embodiment of an autoencoder neural network 500 for anomaly detection. In the illustrated embodiment, an image 502 is fed into the autoencoder network 500 as input, and the encoder 504 compresses the image 502 into a latent vector representation 506 that retains the overall structure and key features of the image 502. The decoder 508 then attempts to reconstruct the original image 502 by decoding the latent vector representation 506 back into a reconstructed image 510.

For anomaly detection use cases, the autoencoder network 500 can be trained on normal or non-anomalous training images. During training, the network 500 learns how to efficiently compress the training images 502 into latent vector representations 506 while minimizing the reconstruction error for the corresponding reconstructed images 510. Since the autoencoder network 500 is trained on normal or non-anomalous images, the reconstruction error for non-anomalous images should be relatively low, while the reconstruction error for images with anomalies should be relatively high. In this manner, anomaly detection 512 can be performed on a target image 502 by processing the image 502 through the autoencoder network 500 to determine the reconstruction error (e.g., compressing the image 502 into a latent vector 506, decoding the latent vector 506 back into a reconstructed image 510, and computing the reconstruction error). The reconstruction error can then be compared to a threshold value (e.g., determined during training) to determine whether the image is normal or anomalous.

The encoder 504 and decoder 508 portions of the autoencoder 500 that process image data can be implemented using standard convolutional neural networks (CNNs) with small linear filters and activation layers that work on the input data and extract features, such as lines or edges at a low level, or complex geometrical shapes at a high level. In the illustrated example, the input images 502 contain shapes with different patterns or colors (e.g., triangle, square, pentagon). In a standard autoencoder architecture, the features that are learned from an input image 502 are compressed down to a low-dimensional latent vector representation 506 in no specific format. The disadvantage of this architecture is that if a new input image 502 is introduced to the autoencoder model 500 (e.g., a triangle with a different color/pattern than previously seen), it would be classified as a defect since it is a different type of input than what the model was trained on. In order to remove this deviation from norm as an anomaly, the entire model 500 must be retrained with the new data, which can be very time consuming.

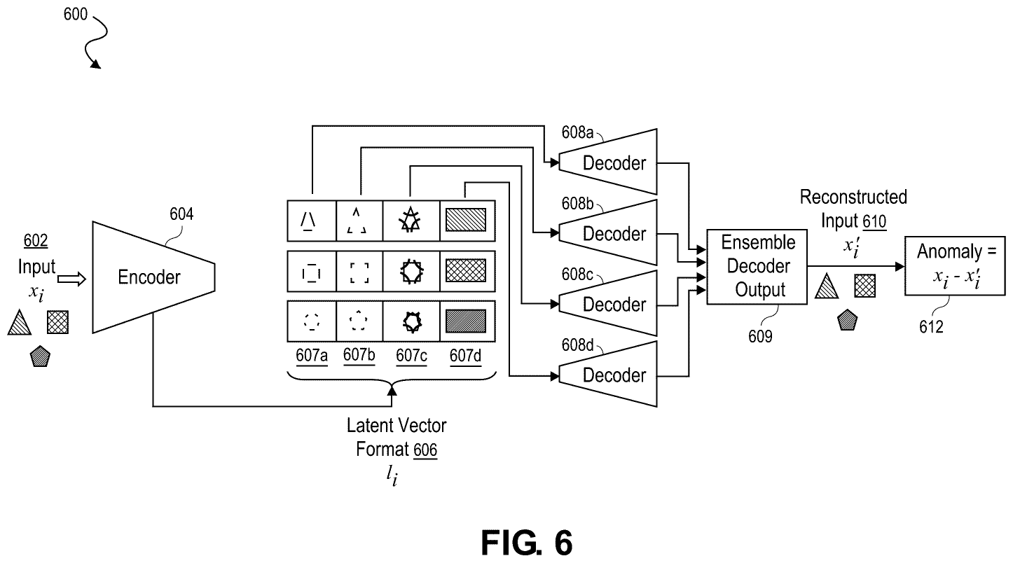

FIG. 6 illustrates an example embodiment of an autoencoder neural network 600 for anomaly detection using disentangled latent vectors. In the illustrated example, the autoencoder architecture 600 employs an alternative method of creating latent vectors 606 such that there is a direct unambiguous mapping between feature vectors that are generated in the hidden layers of the CNN to the compressed latent vector space 606. For example, the CNN layers in the encoder 604 extract distinct sets of features from the input image 602, which are represented as feature vectors. Instead of encoding all feature vectors together into a single latent vector space, the feature vectors are individually encoded into separate latent vector segments 607a-d, which collectively serve as the latent vector representation 606 for the input image 602. In addition, the decoder is spilt into multiple task-specific decoders 608a-d that cater to the decoding of each feature set.

In the illustrated example, the input images 602 are represented as different types of shapes with different colors/patterns, including a triangle, a square, and a pentagon. Moreover, the latent vector representation 606 generated by the encoder 604 includes four latent vector segments 607a-d corresponding to different feature spaces or feature sets extracted from the images/shapes 602. In particular, three of the latent vector segments 607a-c correspond to geometrical feature sets representing the sides, corners, and angles of each shape, respectively, and one of the latent vector segments 607d corresponds to the color space of the respective shapes (where the colors are represented by different patterns in the figure).

Moreover, the autoencoder architecture 600 includes four decoders 608a-d that are each trained to perform a partial decoding/reconstruction task for one of the latent vector segments 607a-d. The reconstructed data output by each decoder 608a-d is fed into an ensemble module 609, which consolidates the reconstructed data output by each decoder 608a-d to generate the reconstructed input image 610. The reconstruction loss can then be computed for the reconstructed image 610, which can be used for anomaly detection, among other use cases.

For example, during training, the autoencoder network 600 learns how to efficiently compress the training images 602 into a set of latent vector segments 607a-d representing distinct feature sets extracted from the images 602, while minimizing the reconstruction loss of the reconstructed images 610. Moreover, for anomaly detection use cases, the autoencoder network 600 can be trained on normal or non-anomalous training images. As a result, the reconstruction loss for non-anomalous images should be relatively low, while the reconstruction loss for images with anomalies should be relatively high. In this manner, the anomaly detection module 612 can detect anomalies/defects in a target image 602 based on the reconstruction loss computed when the target image 602 is processed through the autoencoder network 600 (e.g., by compressing the image 602 into a latent vector representation 606 with disentangled latent vector segments 607a-d, decoding the latent vector segments 607a-d and generating the reconstructed image 610, and computing the reconstruction loss based on the reconstructed image 610). For example, if the reconstruction loss exceeds a threshold value (e.g., the upper limit of reconstruction loss observed for the training images), then the target image 602 may be deemed to represent a defect or anomaly. If the reconstruction loss is below the threshold value, then the target image 602 may be deemed normal or non-anomalous.

Extracting the feature vectors from the encoder 604 and converting them into latent vector segments 607a-d, and assigning decoders 608a-d to perform separate decoding tasks for the respective latent vector segments 607a-d, disentangles the feature vector space and enables the model 600 to be trained on a task/feature basis. In this manner, when a new input image 602 is introduced—such as a triangle with a different color/pattern than previously seen—only the decoder 608d corresponding to the color feature space needs to be retrained to remove the data point as an anomaly. The computation required to retrain the model is significantly reduced and retraining the color-specific decoder 608d has minimal impact, if any, on the rest of the latent vector space, thereby creating a model that is more deterministic.

The model retraining is optimized by considering the impacted decoder 608d as a simple CNN network with the loss value calculated between the decoder-specific portion of the reconstructed image 610 and the disentangled latent vector input 607d. During retraining, only the weights for the impacted task-specific decoder 608d are recalculated, while the optimized weights for the encoder 604 and all other decoders 608a-c unaffected by the new input are frozen and remain intact.

Further, in various embodiments, the disentangled autoencoder network architecture 600 may be combined with other autoencoder embodiments discussed throughout this disclosure. For example, the autoencoder development process of FIG. 2 may be used to automate the parameter selection and training for an optimal disentangled autoencoder network architecture 600. As another example, the unsupervised autoencoder framework of FIGS. 3 and 4 may be implemented in a disentangled autoencoder network architecture 600 to support unsupervised learning. Moreover, while anomaly detection is discussed as an example throughout this disclosure, the disentangled autoencoder network architecture 600 and the other autoencoder embodiments disclosed herein are equally applicable to other autoencoder use cases.

This architecture provides a number of advantages. For example, the computation and time required to retrain the model is significantly reduced. Moreover, if the development or training system is remote from the data ingestion system, as is often the case, the fact that the majority of the weights on the model are frozen during retraining means only the low-dimensional latent vector 606 needs to be transferred over the network, thereby reducing the bandwidth needed to transfer new input data points for retraining. The ability to transfer only the latent vector 606 instead of full resolution input images 602 also caters to data privacy/security concerns during the transfer. For example, given that the latent vector representation 606 is meaningless outside of the model environment, any external 3 rd party intercepting the latent vectors 606 would not have access to the original image data 602.

In some embodiments, since the autoencoder is divided into multiple decoders 608a-d, each decoder 608a-d may be assigned to a separate compute module (or a subset of a compute module) (e.g., VPU, GPU, HDDL, FPGA, CPU, etc.), or even potentially a different device depending on the deployment, thus speeding up the execution.

Further, in some embodiments, during training, there may be multiple versions of the decoder divisions. In particular, when a new outlier is detected, depending on the similarities and differences between the new sample and the existing samples, one decoder or a group of decoders may be impacted and may need to be retrained. For example, a new outlier with only minor differences relative to the existing samples may only require retraining of a single decoder or a small number of encoders. On the other hand, a new outlier that is relatively complex and significantly different from the existing samples could potentially require retraining of multiple decoders, but not the entire set of decoders (e.g., only a subset of the decoders).

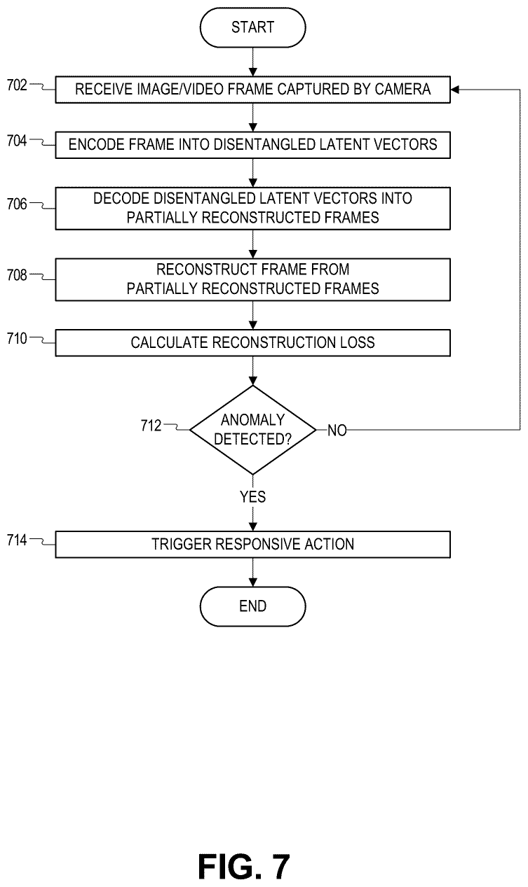

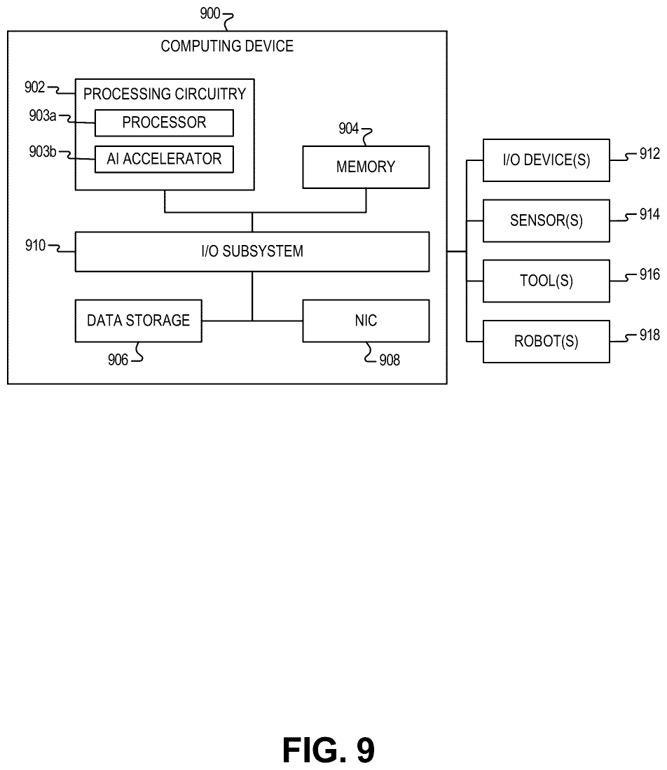

FIG. 7 illustrates a flowchart 700 for performing anomaly detection using a disentangled autoencoder neural network in accordance with certain embodiments. In some embodiments, flowchart 700 may be performed by or using the devices, systems, and functionality described throughout this disclosure (e.g., computing device 900 of FIG. 9 implemented with the autoencoder functionality described herein).

In some embodiments, for example, flowchart 700 may be used to detect a defect or anomaly in an automated industrial process, such as porosity that occurs during a weld performed by a welding robot.

The flowchart begins at block 702 by receiving (via interface circuitry) a frame of a video stream captured by a camera. In some embodiments, for example, the frame may be captured during performance of an industrial process, such as a weld operation or any other type of fabrication, manufacturing, and/or construction process. In other embodiments, the frame may be captured by other types of sensors. In general, a frame may refer to any arrangement of data captured by one or more sensors (e.g., an image/video frame captured by a camera, a depth frame captured by a depth/lidar sensor, a thermal frame captured by an infrared sensor, etc.).

The flowchart then proceeds to blocks 704-710 to process the frame through a disentangled autoencoder network. For example, the flowchart proceeds to block 704 to encode/compress the frame into a set of disentangled latent vectors using the encoder portion of the autoencoder network. In particular, the encoder is trained to extract distinct feature sets from the input frame (e.g., using a CNN) and encode the feature sets into separate latent vectors corresponding to distinct feature spaces, which collectively form the encoded latent vector representation of the input frame. The feature sets can represent any type or category of features detected in the frame, such as lines, edges, outlines, angles, shapes, colors, objects, the relative orientation/layout of the features, and so forth.

The flowchart then proceeds to block 706 to decode/decompress the disentangled latent vectors into partially reconstructed frames (e.g., reconstructed feature sets). In some embodiments, for example, the autoencoder network includes task-specific decoders that are each trained to perform a decoding/reconstruction task for the feature space encoded in one of the latent vectors. In this manner, each decoder decodes its corresponding latent vector into a partially reconstructed frame (e.g., a reconstructed feature set) containing features from the feature space encoded in the particular latent vector.

The flowchart then proceeds to block 708 to reconstruct the original input frame from the partially reconstructed frames generated by the respective decoders. For example, the partially reconstructed frames are consolidated or ensembled into a fully reconstructed frame.

The flowchart then proceeds to block 710 to calculate the reconstruction loss for the reconstructed frame (e.g., based on the differences between the original frame and the reconstructed frame).

The flowchart then proceeds to block 712 to determine whether an anomaly is detected based on the calculated reconstruction loss. In particular, for anomaly detection use cases, the autoencoder network may be trained on normal or non-anomalous training images. As a result, the reconstruction loss for non-anomalous images should be relatively low, while the reconstruction loss for images with anomalies should be relatively high. In this manner, if the reconstruction loss for the reconstructed frame exceeds a threshold value (e.g., the upper limit of reconstruction loss observed for the training images), then it may be inferred that an anomaly or defect occurs in that frame. If the reconstruction loss is below the threshold value, then the frame may be deemed normal or non-anomalous.

If an anomaly is not detected, the flowchart proceeds back to block 702 to receive and process the next frame captured by the camera. If an anomaly is detected, the flowchart proceeds to block 714 to trigger the appropriate remedial action(s), such as stopping, aborting, and/or restarting an industrial process, repeating a portion of the industrial process, flagging certain parts to be evaluated for rework or scrap, and so forth. In some embodiments, for example, a command may be sent to a robot/tool controller to cause the robot/tool to perform the desired action in response to the anomaly.

In this manner, by disentangling the feature vector/latent vector space, retraining the autoencoder network based on new frame content can be streamlined. In some cases, for example, when a non-anomalous frame with previously unseen content is encountered, the autoencoder network may incorrectly detect an anomaly in the frame (e.g., a false positive). Instead of retraining the entire autoencoder network to recognize the content in this frame as non-anomalous, individual decoder(s) whose feature spaces are impacted by the new content can be selectively retrained.

At this point, the flowchart may be complete. In some embodiments, however, the flowchart may restart and/or certain blocks may be repeated. For example, in some embodiments, the flowchart may restart at block 702 to continue receiving frames and performing anomaly detection.

### Example Autoencoder Embodiments

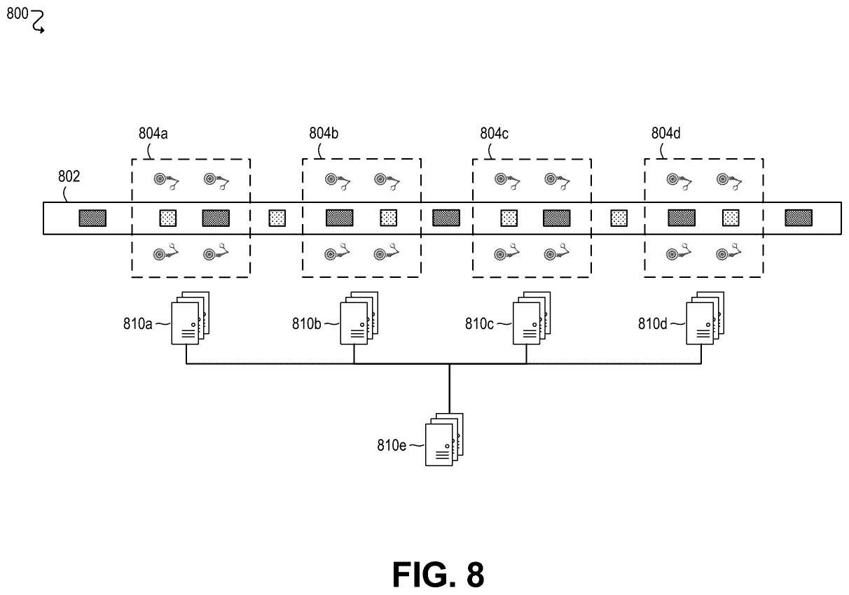

FIG. 8 illustrates an example embodiment of an anomaly detection system 800 for an industrial use case. In particular, the industrial use case involves anomaly detection for product manufacturing on a production line 802 in a factory.

In the illustrated example, the production line 802 is organized into a series of modular cells 804a-d throughout the factory floor, and products that are being assembled (e.g., vehicles) move down the line 802 from cell to cell. Each cell 804a-d contains a collection of devices and equipment 805 for performing certain tasks required to assemble the product, such as multiple autonomous robots equipped with certain tool(s).

Moreover, various compute resources 810a-d are deployed to control the tasks performed in each cell 804a-d. In the illustrated embodiment, for example, the compute resources 810a-d in each cell 804a-d include controller(s) for the robots, controller(s) for the tools used by the robots, and a control computer with a user interface for the factory operators to control the particular cell (e.g., an Industrial PC (IPC)). The compute resources 810a-d in each cell 804a-d also interface with an anomaly detection server 810e, which is used to perform anomaly detection on the production line 802. An anomaly may refer to any deviation from what is standard, normal, or expected. In some cases, an anomaly may or may not rise to the level of a defect or fault.

As an example, an automotive factory that manufactures automobiles may have thousands of autonomous robots distributed throughout the respective cells of a production line. Each robot is typically equipped with a tool of some kind—such as a glue gun, welding gun, riveting machine, pump, or screwdriver—which the robot uses to perform a specific task required to assemble an automobile. For example, many of the robots (e.g., hundreds or even thousands) may use a welding gun to perform spot welds to weld pieces of metal together, such as to assemble the chassis of a vehicle. For a large factory that produces hundreds or even thousands of vehicles per day—with thousands of welds required per vehicle—millions of welds can be performed in a single day of production. For example, assuming a production rate of 1,000 vehicles per day with 5,000 welds required per vehicle, 5,000,000 welds are performed each day.

Due to the large scale of production (e.g., the number of welds performed per vehicle and the volume of vehicles produced per day), it is impractical to manually inspect every weld on every vehicle. Thus, to ensure the quality of the welds, factory engineers and operators typically perform manual quality control inspections on a very limited sample of welding spots and production vehicles. For example, quality control is traditionally performed using a sampling method, where a random vehicle is selected from the production line each day and various aspects of its production quality are evaluated by factory engineers, such as the weld quality for a representative set of welding spots on the vehicle. This sampling method of quality control is costly and labor intensive, however, and its efficacy is extremely limited, as it leaves many unanswered questions about the production quality of the remaining vehicles that are not inspected each day.

In the illustrated embodiment, autoencoder networks designed for anomaly detection (e.g., as described throughout this disclosure) can be used to implement various quality control use cases on the production line, such as detecting faulty production tasks (e.g., faulty welds), detecting faulty components used or produced during production, proactively detecting and/or performing preventive measures that are likely to prevent or minimize faults during production (e.g., configuration changes and/or maintenance tasks), and so forth.

In the illustrated embodiment, for example, each robot uses a tool to perform an assigned task based on specific reference parameters that control how the task is to be performed. Moreover, each time a task is performed, the controller(s) 810a-d of the tool and/or robot generate a data stream with metadata associated with the completed task. For example, the data stream may include a combination of configuration and performance parameters, such as the reference parameters used to configure the robot or tool to perform the task, along with parameters indicating the actual performance of the completed task based on data captured or measured by sensors and other devices (e.g., image/video frames captured by a camera).

In some embodiments, for example, the data stream may be represented as a file or data object (e.g., a JSON object) with a collection of values corresponding to the parameters, or “features,” associated with the completed task. The underlying data values in the data stream—which tend to be heavily represented using time-series data—can include any representation of data from any type or combination of modalities, including configuration data for tasks and equipment (e.g., robots, tools), performance data captured by sensors and other devices, visual data—such as images and video—captured by cameras and other visual sensors, audio captured by microphones, and so forth.

As an example, for a spot weld performed by a robot using a welding gun, the data stream may include parameters with the following types of information (among other examples):
(i) the type, thickness, and resistance of the metal being welded;
(ii) the time/date in which the spot weld is performed;
(iii) the location in the factory where the spot weld is performed (e.g., the particular cell 804a-d on the production line);
(iv) the location of the weld on the product being produced (e.g., on a vehicle);
(v) an identifier of the particular robot, robot arm, and welding gun that performed the spot weld;
(vi) maintenance history for the welding gun/controller (e.g., the last time the controller and/or welding gun received maintenance and the type of that maintenance);
(vii) the voltage curve, current curve, force, and torque for the spot weld; and
(viii) the health of the electrodes on the welding gun.

The data streams generated by the controllers 810a-d for the same type of tool will typically have the same information model and streaming format across cells 804a-d, but the characteristics and underlying data values within the data streams will often differ based on the specific tasks assigned to the robots using that tool in each cell 804a-d.

For example, for automobile manufacturing, robots with a welding gun may perform spot welds on different parts of a vehicle in different cells 804a-d. Based on the type and thickness of metal used for the spot welds in different cells 804a-d, the data generated by the welding gun controllers 810a-d may differ considerably and is very dynamic in a tight supply chain automated environment. Similarly, robots with a glue gun may apply glue to different parts of a vehicle in different cells 804a-d, and the data generated by the glue gun controllers 810a-d may differ considerably based on the material of the sheets that are being glued, the glue viscosity, and the ambient temperature and humidity level.

Moreover, the data streams generated by the controllers 810a-d can be ingested and analyzed—at the edge or in the cloud—to train predictive analytics models using machine learning algorithms. For example, data streams from the welding gun controllers 810a-d may be used to train an autoencoder network to detect faulty welds.

In this manner, autoencoder networks can be trained to perform anomaly detection to automate quality control on the production line based on the data streams generated for any task or stage of production, such as welding, riveting, gluing, screwdriving, painting, and so forth. As a result, quality control can be performed automatically without relying on manual inspections—and with greater accuracy—for 100% of the production tasks and output as opposed to only a very small percentage or sample evaluated through manual inspections. Moreover, while quality control for industrial use cases is discussed as an example, the described solution can be leveraged for any use case involving predictive analytics, anomaly/fault detection, machine learning, and/or artificial intelligence.

FIG. 9 illustrates an example embodiment of a computing device 900 for implementing various use cases using autoencoder neural networks (e.g., anomaly detection). In some embodiments, for example, computing device 900 may be used to implement the autoencoder and/or anomaly detection functionality described throughout this disclosure.

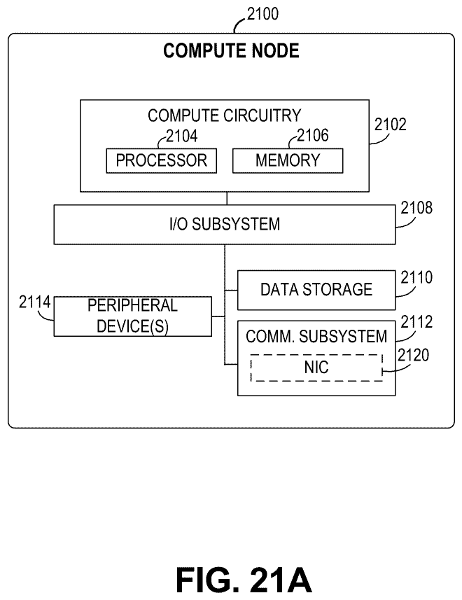

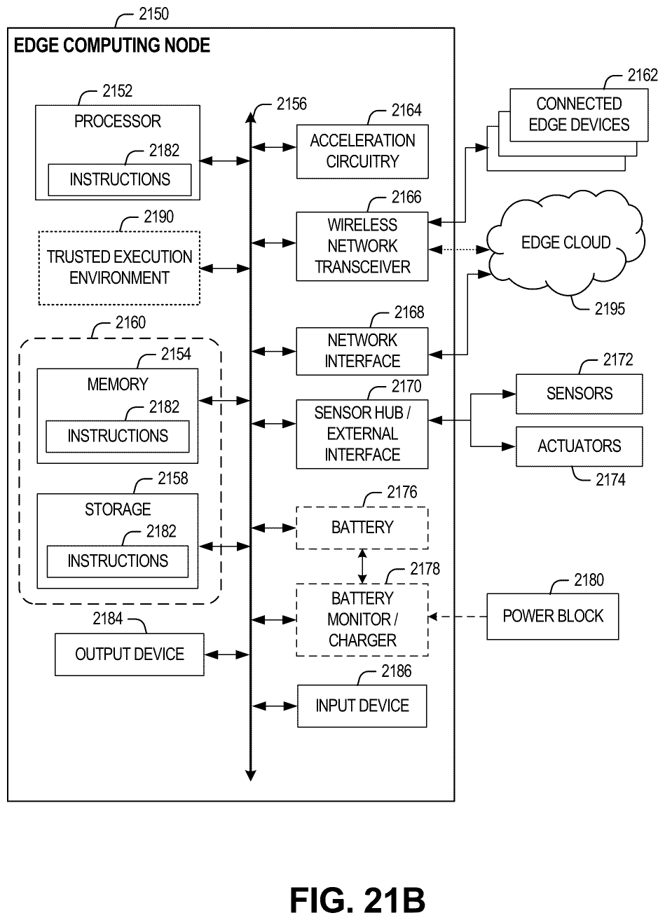

In the illustrated embodiment, computing device 900 includes processing circuitry 902, memory 904, data storage device 906, network interface controller (NIC) 908, and input/output (I/O) subsystem 910. The processing circuitry 902 includes a collection of processing components 903, such as a processor 903a (e.g., central processing unit (CPU), microcontroller, etc.) and an artificial intelligence (AI) accelerator 903b (e.g., co-processor, ASIC, FPGA, etc.). The computing device 900 is also coupled to various other devices (e.g., via I/O subsystem 910 and/or NIC 908), such as I/O device(s) 912 (e.g., display/touchscreen, keyboard, mouse, etc.), sensor(s) 914 (e.g., voltage/current sensors, temperature/thermal sensors, humidity sensors, pressure sensors, camera sensors, audio sensors, depth sensors, lidar sensors, infrared (IR) sensors, accelerometers, etc.), tool(s) 916 (e.g., welding gun, glue gun, riveting machine, screwdriver, pump, etc.), and/or robot(s) 918. In some embodiments, certain components of computing device 900 may be similar to those shown and described in connection with the computing devices of FIGS. 21A-B.

Further, computing device 900 may be used to implement any or all aspects of the autoencoder and/or anomaly detection functionality described throughout this disclosure. In some embodiments, for example, computing device 900 may receive data streams generated by tools 916, robots 918, smart cameras, and/or other manufacturing equipment/machines (and/or their associated sensors 914) and perform anomaly detection using autoencoder networks trained on the respective data streams. Computing device 900 may also perform anomaly detection in any other contexts or use cases, including for vehicles, aircraft, mobile devices/user equipment (UE), and so forth. In some embodiments, computing device 900 may be, may include, or may be included in an industrial personal computer (PC), fault detection system, edge computing system, edge server, edge node, edge cloud system, edge cloud server, edge cloud node, multi-access edge computing (MEC) system, MEC server, MEC node, cloud computing system, cloud server, cloud node, server, server device, server node, client, client device, client node, gateway, gateway device, and/or gateway node, among other examples.

In some embodiments, computing device 900 may be implemented as a standalone device that interfaces or communicates with the I/O devices 912, sensors 914, tools 916, and/or robots 918. Alternatively, or additionally, computing device 900 may be integrated with, or embedded as part of, one or more of the I/O devices 912, sensors 914, tools 916, and/or robots 918. Further, in some embodiments, the functionality of computing device 900 may be implemented or distributed across multiple devices (e.g., multiple servers, computing devices, controllers, tools, robots, etc.).

In some embodiments, for example, computing device 900 may be an edge server used to perform predictive analytics on the data streams generated by the tools 916 and/or robots 918 (and/or their associated sensors 914). Additionally, or alternatively, computing device 900 may be a tool or robot controller used to control one or more tools 916 and/or robots 918 and perform predictive analytics on their corresponding data streams. For example, computing device 900 may be a controller embedded within a particular tool 916 or robot 918, or computing device 900 may be an external controller used to control one or more tools 916 and/or robots 918.

Moreover, the tools 916 and/or robots 918 can include any type of tools, robots, machines, equipment, or other suitable devices depending on the particular use case. For example, the tools 916 may include welding guns, glue guns, riveting machines, screwdrivers, pumps, and/or other types of tools, machines, or equipment. Moreover, the robots 918 may include any devices, machines, and/or equipment for automating and/or aiding in the performance of certain tasks, including articulated robots, cartesian robots, cylindrical robots, polar/spherical robots, SCARA robots, delta robots, and humanoids, among other examples.

Articulated robots—which are also referred to as robotic arms or manipulator arms—are robots with rotary joints that resemble a human arm. For example, an articulated robot typically includes an arm with multiple links connected by rotary joints, which is attached to a base via a twisting joint. Each joint is an axis that provides an additional degree of freedom or range of motion, and each robot often includes four to six axes.

Cartesian coordinate robots—which are also referred to as rectilinear, gantry robots, and x-y-z robots—are designed for linear movement based on the Cartesian coordinate system (X, Y, and Z). For example, a cartesian robot typically includes three prismatic joints for linear movement along an X, Y, and Z axis, and may further include an attached wrist for rotational movement, such as three rotary joints to adjust its orientation in space.

Cylindrical coordinate robots include at least one rotary joint at the base and at least one prismatic joint to connect its links. The rotary joint provides rotational motion along the joint axis, while the prismatic joint provides linear motion. In this manner, cylindrical robots can move vertically and horizontally by sliding.

Polar robots—which are also referred to as spherical coordinate robots— typically include an arm connected to a base with a twisting joint, along with two rotary joints and one linear joint, forming a polar coordinate system.

SCARA robots (Selective Compliance Assembly Robot Arm) include two parallel joints for movement in the X-Y plane and are typically used for assembly applications that require precise lateral movements.

Delta robots—which are also referred to as parallel link robots—are spider-like robots with jointed parallelograms (e.g., parallel links) connected to a common base. Delta robots are often used for tasks that require precise movement and/or maneuvering.

Humanoids are robots that resemble a human, such as a robot that includes a body, arms, legs, and optionally a head.

### Example Computing Embodiments

The following sections present examples of various computing embodiments that may be used to implement the autoencoder solution described throughout this disclosure. In particular, any of the devices, systems, or functionality described in the preceding sections may be implemented using the computing embodiments described below.

### Edge Computing

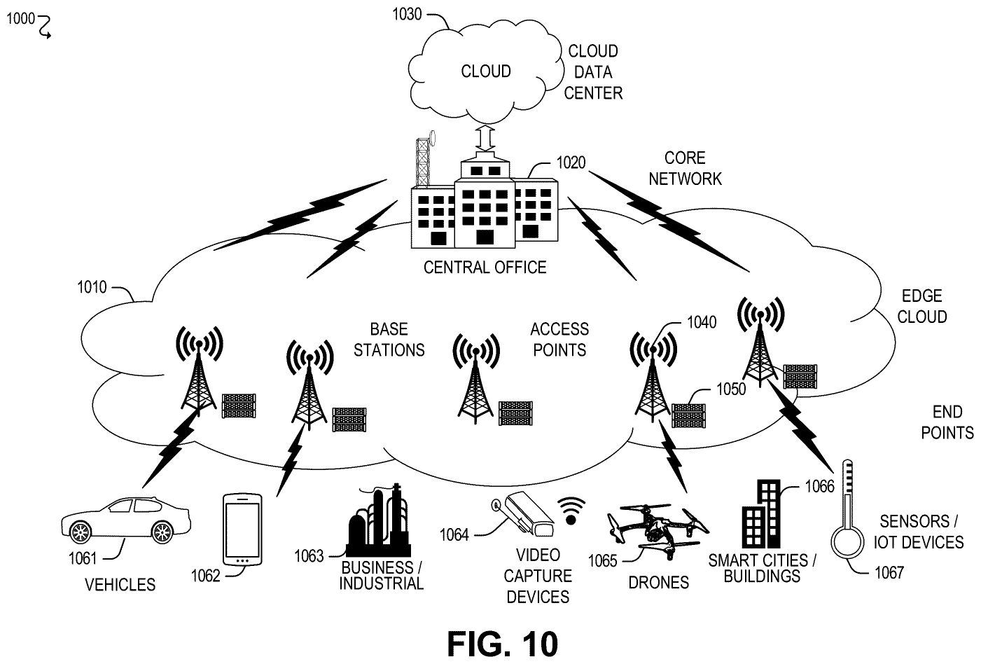

FIG. 10 is a block diagram 1000 showing an overview of a configuration for edge computing, which includes a layer of processing referred to in many of the following examples as an “edge cloud”. As shown, the edge cloud 1010 is co-located at an edge location, such as an access point or base station 1040, a local processing hub 1050, or a central office 1020, and thus may include multiple entities, devices, and equipment instances. The edge cloud 1010 is located much closer to the endpoint (consumer and producer) data sources 1060 (e.g., autonomous vehicles 1061, user equipment 1062, business and industrial equipment 1063, video capture devices 1064, drones 1065, smart cities and building devices 1066, sensors and IoT devices 1067, etc.) than the cloud data center 1030. Compute, memory, and storage resources which are offered at the edges in the edge cloud 1010 are critical to providing ultra-low latency response times for services and functions used by the endpoint data sources 1060 as well as reduce network backhaul traffic from the edge cloud 1010 toward cloud data center 1030 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

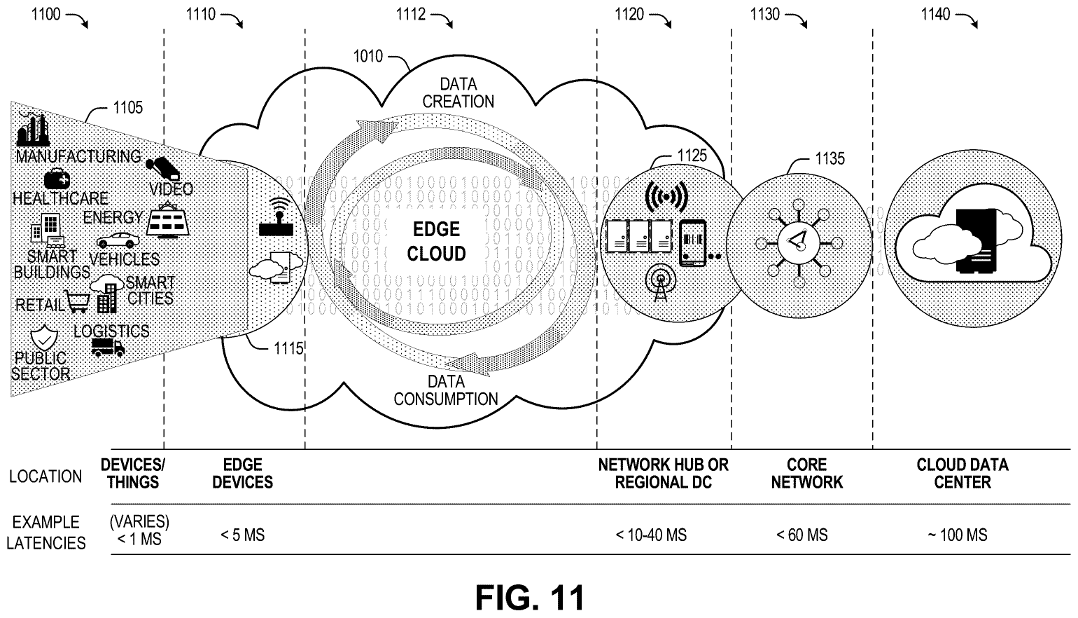

FIG. 11 illustrates operational layers among endpoints, an edge cloud, and cloud computing environments. Specifically, FIG. 11 depicts examples of computational use cases 1105, utilizing the edge cloud 1010 among multiple illustrative layers of network computing. The layers begin at an endpoint (devices and things) layer 1100, which accesses the edge cloud 1010 to conduct data creation, analysis, and data consumption activities. The edge cloud 1010 may span multiple network layers, such as an edge devices layer 1110 having gateways, on-premise servers, or network equipment (nodes 1115) located in physically proximate edge systems; a network access layer 1120, encompassing base stations, radio processing units, network hubs, regional data centers (DC), or local network equipment (equipment 1125); and any equipment, devices, or nodes located therebetween (in layer 1112, not illustrated in detail). The network communications within the edge cloud 1010 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1100, under 5 ms at the edge devices layer 1110, to even between 10 to 40 ms when communicating with nodes at the network access layer 1120. Beyond the edge cloud 1010 are core network 1130 and cloud data center 1140 layers, each with increasing latency (e.g., between 50-60 ms at the core network layer 1130, to 100 or more ms at the cloud data center layer). As a result, operations at a core network data center 1135 or a cloud data center 1145, with latencies of at least 50 to 100 ms or more, will not be able to accomplish many time-critical functions of the use cases 1105. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1135 or a cloud data center 1145, a central office or content data network may be considered as being located within a “near edge” layer (“near” to the cloud, having high latency values when communicating with the devices and endpoints of the use cases 1105), whereas an access point, base station, on-premise server, or network gateway may be considered as located within a “far edge” layer (“far” from the cloud, having low latency values when communicating with the devices and endpoints of the use cases 1105). It will be understood that other categorizations of a particular network layer as constituting a “close”, “local”, “near”, “middle”, or “far” edge may be based on latency, distance, number of network hops, or other measurable characteristics, as measured from a source in any of the network layers 1100-1140.

The various use cases 1105 may access resources under usage pressure from incoming streams, due to multiple services utilizing the edge cloud. To achieve results with low latency, the services executed within the edge cloud 1010 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1010 may provide the ability to serve and respond to multiple applications of the use cases 1105 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 1010 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1010 (network layers 1100-1140), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1010.

As such, the edge cloud 1010 is formed from network components and functional features operated by and within edge gateway nodes, edge aggregation nodes, or other edge compute nodes among network layers 1110-1130. The edge cloud 1010 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1010 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 1010 may be servers, multi-tenant servers, appliance computing devices, and/or any other type of computing devices. For example, the edge cloud 1010 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 21B. The edge cloud 1010 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

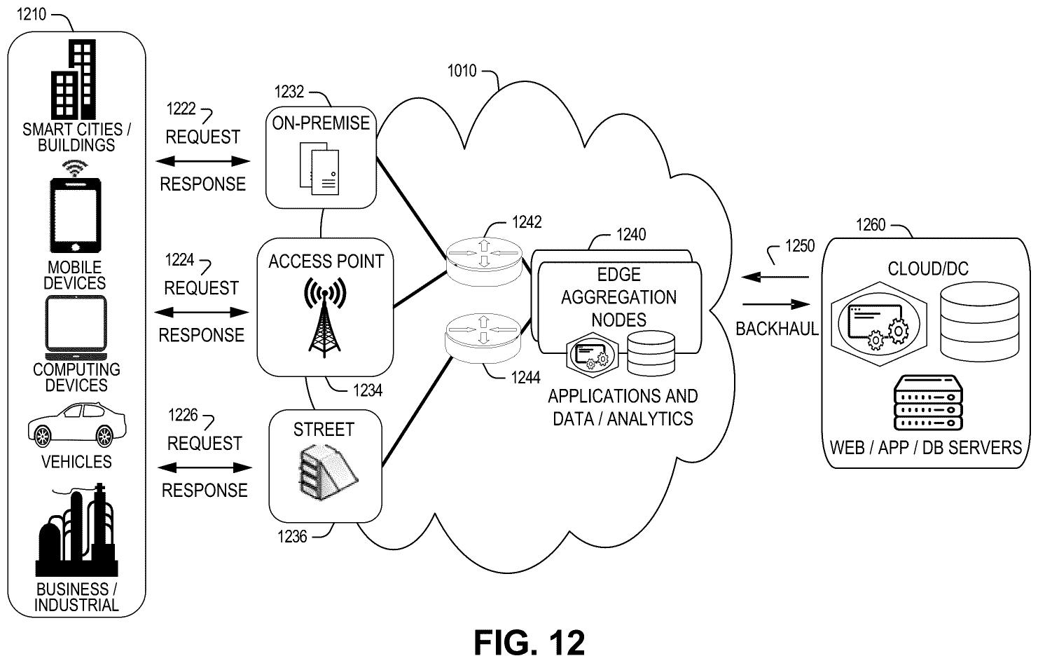

In FIG. 12, various client endpoints 1210 (in the form of mobile devices, computers, autonomous vehicles, business computing equipment, industrial processing equipment) exchange requests and responses that are specific to the type of endpoint network aggregation. For instance, client endpoints 1210 may obtain network access via a wired broadband network, by exchanging requests and responses 1222 through an on-premise network system 1232. Some client endpoints 1210, such as mobile computing devices, may obtain network access via a wireless broadband network, by exchanging requests and responses 1224 through an access point (e.g., cellular network tower) 1234. Some client endpoints 1210, such as autonomous vehicles may obtain network access for requests and responses 1226 via a wireless vehicular network through a street-located network system 1236. However, regardless of the type of network access, the TSP may deploy aggregation points 1242, 1244 within the edge cloud 1010 to aggregate traffic and requests. Thus, within the edge cloud 1010, the TSP may deploy various compute and storage resources, such as at edge aggregation nodes 1240, to provide requested content. The edge aggregation nodes 1240 and other systems of the edge cloud 1010 are connected to a cloud or data center 1260, which uses a backhaul network 1250 to fulfill higher-latency requests from a cloud/data center for websites, applications, database servers, etc. Additional or consolidated instances of the edge aggregation nodes 1240 and the aggregation points 1242, 1244, including those deployed on a single server framework, may also be present within the edge cloud 1010 or other areas of the TSP infrastructure.

### Internet-of-Things

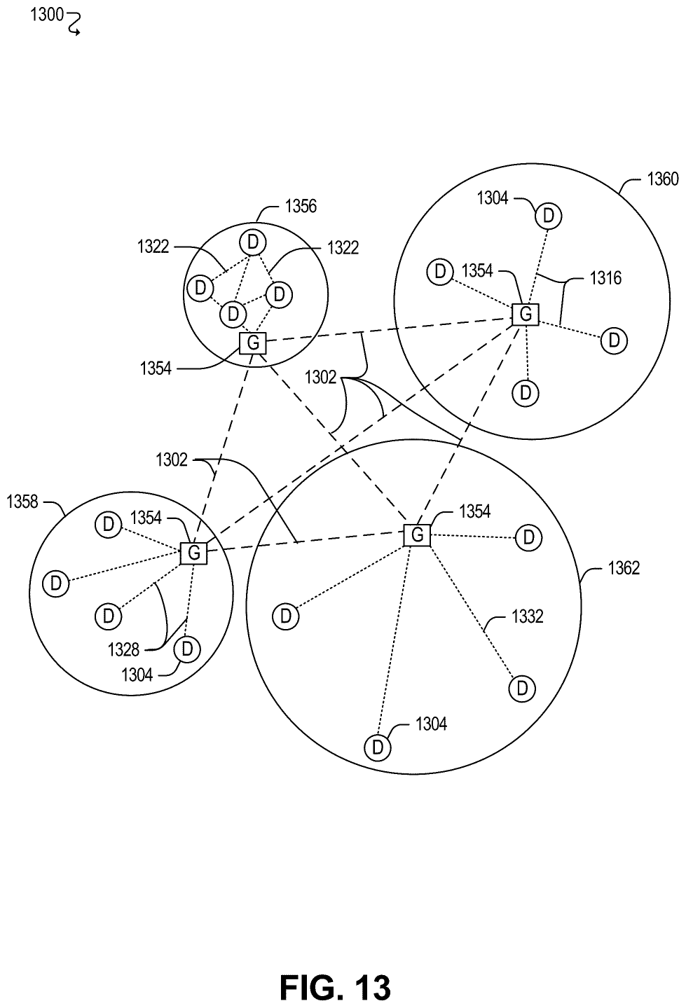

FIG. 13 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, doorbells (e.g., doorbell cameras), cameras, alarms, motion sensors, and the like. The IoT devices may be accessible through remote computers, servers, and other systems, for example, to control systems or access data.

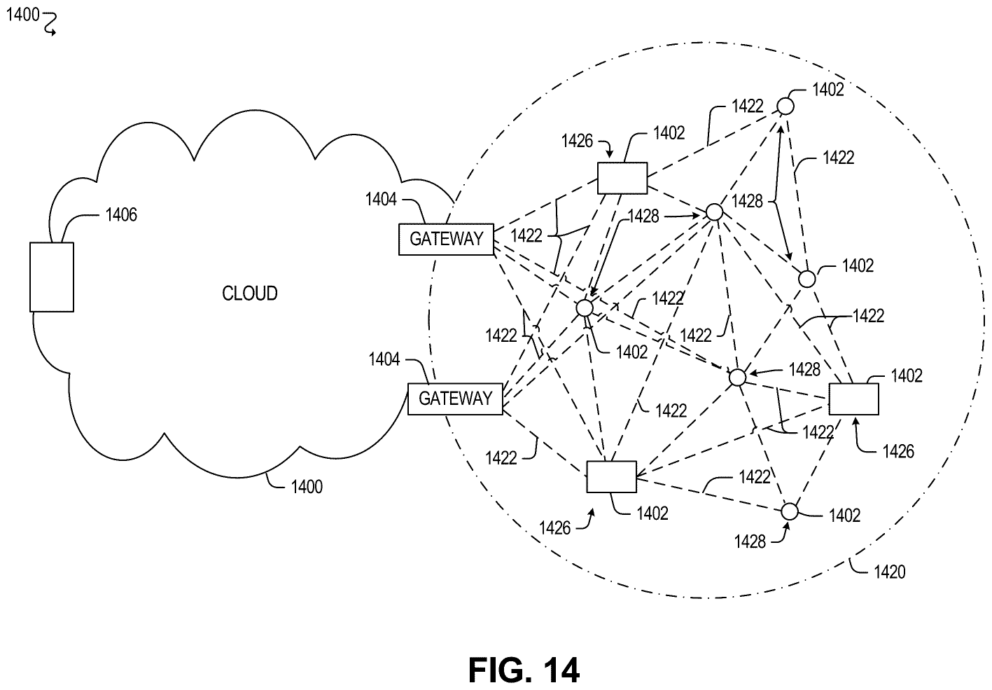

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 13 and 14, present a number of new challenges in a heterogeneous network of connectivity comprising a combination of wired and wireless technologies.

FIG. 13 specifically provides a simplified drawing of a domain topology that may be used for a number of internet-of-things (IoT) networks comprising IoT devices 1304, with the IoT networks 1356, 1358, 1360, 1362, coupled through backbone links 1302 to respective gateways 1354. For example, a number of IoT devices 1304 may communicate with a gateway 1354, and with each other through the gateway 1354. To simplify the drawing, not every IoT device 1304, or communications link (e.g., link 1316, 1322, 1328, or 1332) is labeled. The backbone links 1302 may include any number of wired or wireless technologies, including optical networks, and may be part of a local area network (LAN), a wide area network (WAN), or the Internet. Additionally, such communication links facilitate optical signal paths among both IoT devices 1304 and gateways 1354, including the use of MUXing/deMUXing components that facilitate interconnection of the various devices.

The network topology may include any number of types of IoT networks, such as a mesh network provided with the network 1356 using Bluetooth low energy (BLE) links 1322. Other types of IoT networks that may be present include a wireless local area network (WLAN) network 1358 used to communicate with IoT devices 1304 through IEEE 802.11 (Wi-Fi®) links 1328, a cellular network 1360 used to communicate with IoT devices 1304 through an LTE/LTE-A (4G) or 5G cellular network, and a low-power wide area (LPWA) network 1362, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into “fog” devices or integrated into “Edge” computing systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 1304, such as over the backbone links 1302, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability, and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 1356, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 1358, for instance, may use systems that perform standards conversion to provide multi-standard connectivity, enabling IoT devices 1304 using different protocols to communicate. Further systems may provide seamless interconnectivity across a multi-standard infrastructure comprising visible Internet resources and hidden Internet resources.

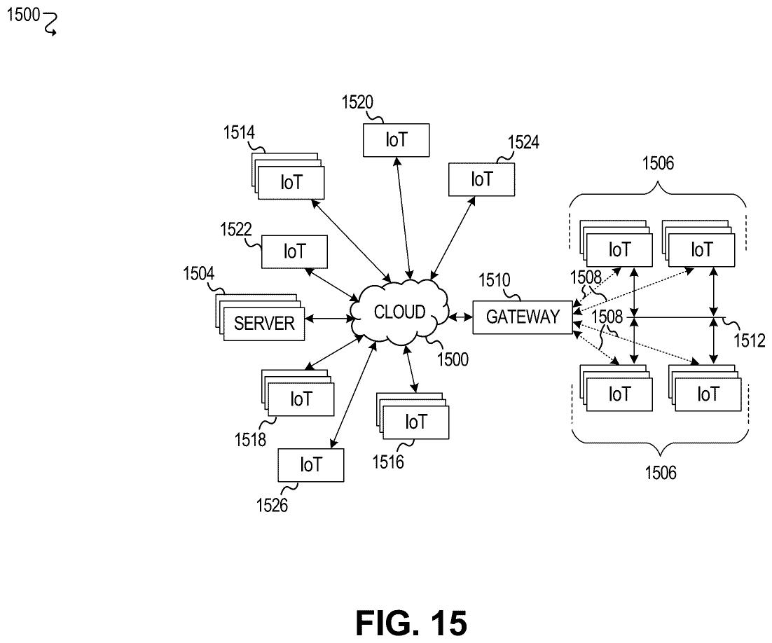

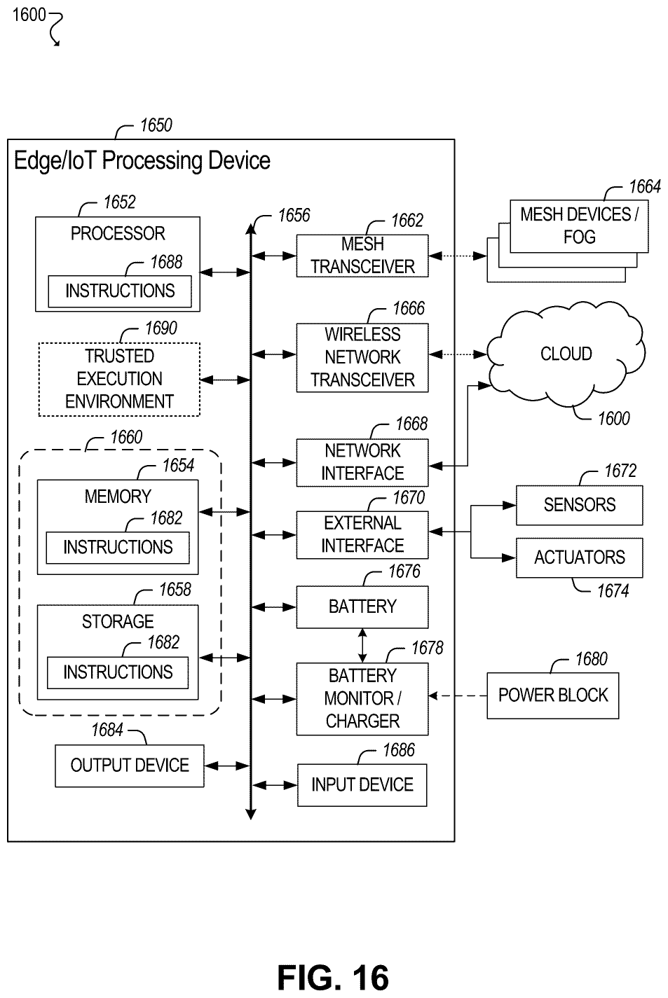

Communications in the cellular network 1360, for instance, may be enhanced by systems that offload data, extend communications to more remote devices, or both. The LPWA network 1362 may include systems that perform non-Internet protocol (IP) to IP interconnections, addressing, and routing. Further, each of the IoT devices 1304 may include the appropriate transceiver for wide area communications with that device. Further, each IoT device 1304 may include other transceivers for communications using additional protocols and frequencies. This is discussed further with respect to the communication environment and hardware of an IoT processing device depicted in FIGS. 15 and 16.

Finally, clusters of IoT devices may be equipped to communicate with other IoT devices as well as with a cloud network. This may allow the IoT devices to form an ad-hoc network between the devices, allowing them to function as a single device, which may be termed a fog device, fog platform, or fog network. This configuration is discussed further with respect to FIG. 14 below.

FIG. 14 illustrates a cloud computing network in communication with a mesh network of IoT devices (devices 1402) operating as a fog platform in a networked scenario. The mesh network of IoT devices may be termed a fog network 1420, established from a network of devices operating at the Edge of the cloud 1400. To simplify the diagram, not every IoT device 1402 is labeled.

The fog network 1420 may be considered to be a massively interconnected network wherein a number of IoT devices 1402 are in communications with each other, for example, by radio links 1422. The fog network 1420 may establish a horizontal, physical, or virtual resource platform that can be considered to reside between IoT Edge devices and cloud or data centers. A fog network, in some examples, may support vertically-isolated, latency-sensitive applications through layered, federated, or distributed computing, storage, and network connectivity operations. However, a fog network may also be used to distribute resources and services at and among the Edge and the cloud. Thus, references in the present document to the “Edge”, “fog”, and “cloud” are not necessarily discrete or exclusive of one another.

As an example, the fog network 1420 may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1402 are shown in this example, gateways 1404, data aggregators 1426, and sensors 1428, although any combinations of IoT devices 1402 and functionality may be used. The gateways 1404 may be Edge devices that provide communications between the cloud 1400 and the fog network 1420, and may also provide the backend process function for data obtained from sensors 1428, such as motion data, flow data, temperature data, and the like. The data aggregators 1426 may collect data from any number of the sensors 1428, and perform the back end processing function for the analysis. The results, raw data, or both may be passed along to the cloud 1400 through the gateways 1404. The sensors 1428 may be full IoT devices 1402, for example, capable of both collecting data and processing the data. In some cases, the sensors 1428 may be more limited in functionality, for example, collecting the data and allowing the data aggregators 1426 or gateways 1404 to process the data.

Communications from any IoT device 1402 may be passed along a convenient path between any of the IoT devices 1402 to reach the gateways 1404. In these networks, the number of interconnections provide substantial redundancy, allowing communications to be maintained, even with the loss of a number of IoT devices 1402. Further, the use of a mesh network may allow IoT devices 1402 that are very low power or located at a distance from infrastructure to be used, as the range to connect to another IoT device 1402 may be much less than the range to connect to the gateways 1404.

The fog network 1420 provided from these IoT devices 1402 may be presented to devices in the cloud 1400, such as a server 1406, as a single device located at the Edge of the cloud 1400, e.g., a fog network operating as a device or platform. In this example, the alerts coming from the fog platform may be sent without being identified as coming from a specific IoT device 1402 within the fog network 1420. In this fashion, the fog network 1420 may be considered a distributed platform that provides computing and storage resources to perform processing or data-intensive tasks such as data analytics, data aggregation, and machine-learning, among others.

In some examples, the IoT devices 1402 may be configured using an imperative programming style, e.g., with each IoT device 1402 having a specific function and communication partners. However, the IoT devices 1402 forming the fog platform may be configured in a declarative programming style, enabling the IoT devices 1402 to reconfigure their operations and communications, such as to determine needed resources in response to conditions, queries, and device failures. As an example, a query from a user located at a server 1406 about the operations of a subset of equipment monitored by the IoT devices 1402 may result in the fog network 1420 device the IoT devices 1402, such as particular sensors 1428, needed to answer the query. The data from these sensors 1428 may then be aggregated and analyzed by any combination of the sensors 1428, data aggregators 1426, or gateways 1404, before being sent on by the fog network 1420 to the server 1406 to answer the query. In this example, IoT devices 1402 in the fog network 1420 may select the sensors 1428 used based on the query, such as adding data from flow sensors or temperature sensors. Further, if some of the IoT devices 1402 are not operational, other IoT devices 1402 in the fog network 1420 may provide analogous data, if available.

In other examples, the operations and functionality described herein may be embodied by an IoT or Edge compute device in the example form of an electronic processing system, within which a set or sequence of instructions may be executed to cause the electronic processing system to perform any one of the methodologies discussed herein, according to an example embodiment. The device may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine.

Further, while only a single machine may be depicted and referenced in the examples above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor, set of processors, or processing circuitry (e.g., a computer) to individually or jointly execute instructions to perform any one or more of the methodologies discussed herein. Accordingly, in various examples, applicable means for processing (e.g., processing, controlling, generating, evaluating, etc.) may be embodied by such processing circuitry.

FIG. 15 illustrates a drawing of a cloud computing network, or cloud 1500, in communication with a number of Internet of Things (IoT) devices. The cloud 1500 may represent the Internet, or may be a local area network (LAN), or a wide area network (WAN), such as a proprietary network for a company. The IoT devices may include any number of different types of devices, grouped in various combinations. For example, a traffic control group 1506 may include IoT devices along streets in a city. These IoT devices may include stoplights, traffic flow monitors, cameras, weather sensors, and the like. The traffic control group 1506, or other subgroups, may be in communication with the cloud 1500 through wired or wireless links 1508, such as LPWA links, and the like. Further, a wired or wireless sub-network 1512 may allow the IoT devices to communicate with each other, such as through a local area network, a wireless local area network, and the like. The IoT devices may use another device, such as a gateway 1510 or 1528 to communicate with remote locations such as the cloud 1500; the IoT devices may also use one or more servers 1530 to facilitate communication with the cloud 1500 or with the gateway 1510. For example, the one or more servers 1530 may operate as an intermediate network node to support a local Edge cloud or fog implementation among a local area network. Further, the gateway 1528 that is depicted may operate in a cloud-to-gateway-to-many Edge devices configuration, such as with the various IoT devices 1514, 1520, 1524 being constrained or dynamic to an assignment and use of resources in the cloud 1500.

Other example groups of IoT devices may include remote weather stations 1514, local information terminals 1516, alarm systems 1518, automated teller machines 1520, alarm panels 1522, or moving vehicles, such as emergency vehicles 1524 or other vehicles 1526, among many others. Each of these IoT devices may be in communication with other IoT devices, with servers 1504, with another IoT fog device or system (not shown, but depicted in FIG. 14), or a combination therein. The groups of IoT devices may be deployed in various residential, commercial, and industrial settings (including in both private or public environments).

As may be seen from FIG. 15, a large number of IoT devices may be communicating through the cloud 1500. This may allow different IoT devices to request or provide information to other devices autonomously. For example, a group of IoT devices (e.g., the traffic control group 1506) may request a current weather forecast from a group of remote weather stations 1514, which may provide the forecast without human intervention. Further, an emergency vehicle 1524 may be alerted by an automated teller machine 1520 that a burglary is in progress. As the emergency vehicle 1524 proceeds towards the automated teller machine 1520, it may access the traffic control group 1506 to request clearance to the location, for example, by lights turning red to block cross traffic at an intersection in sufficient time for the emergency vehicle 1524 to have unimpeded access to the intersection.

Clusters of IoT devices, such as the remote weather stations 1514 or the traffic control group 1506, may be equipped to communicate with other IoT devices as well as with the cloud 1500. This may allow the IoT devices to form an ad-hoc network between the devices, allowing them to function as a single device, which may be termed a fog device or system (e.g., as described above with reference to FIG. 14).

FIG. 16 is a block diagram of an example of components that may be present in an IoT device 1650 for implementing the techniques described herein. The IoT device 1650 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1650, or as components otherwise incorporated within a chassis of a larger system. Additionally, the block diagram of FIG. 16 is intended to depict a high-level view of components of the IoT device 1650. However, some of the components shown may be omitted, additional components may be present, and different arrangement of the components shown may occur in other implementations.

The IoT device 1650 may include processor circuitry in the form of, for example, a processor 1652, which may be a microprocessor, a multi-core processor, a multithreaded processor, an ultra-low voltage processor, an embedded processor, or other known processing elements. The processor 1652 may be a part of a system on a chip (SoC) in which the processor 1652 and other components are formed into a single integrated circuit, or a single package, such as the Edison™ or Galileo™ SoC boards from Intel. As an example, the processor 1652 may include an Intel® Architecture Core™ based processor, such as a Quark™, an Atom™, an i3, an i5, an i7, or an MCU-class processor, or another such processor available from Intel® Corporation, Santa Clara, CA. However, any number other processors may be used, such as available from Advanced Micro Devices, Inc. (AMD) of Sunnyvale, CA, a MIPS-based design from MIPS Technologies, Inc. of Sunnyvale, CA, an ARM-based design licensed from ARM Holdings, Ltd. or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 1652 may communicate with a system memory 1654 over an interconnect 1656 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 1658 may also couple to the processor 1652 via the interconnect 1656. In an example the storage 1658 may be implemented via a solid state disk drive (SSDD). Other devices that may be used for the storage 1658 include flash memory cards, such as SD cards, microSD cards, xD picture cards, and the like, and USB flash drives. In low power implementations, the storage 1658 may be on-die memory or registers associated with the processor 1652. However, in some examples, the storage 1658 may be implemented using a micro hard disk drive (HDD). Further, any number of new technologies may be used for the storage 1658 in addition to, or instead of, the technologies described, such resistance change memories, phase change memories, holographic memories, or chemical memories, among others.

The components may communicate over the interconnect 1656. The interconnect 1656 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1656 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 1662, 1666, 1668, or 1670. Accordingly, in various examples, applicable means for communicating (e.g., receiving, transmitting, etc.) may be embodied by such communications circuitry.

The interconnect 1656 may couple the processor 1652 to a mesh transceiver 1662, for communications with other mesh devices 1664. The mesh transceiver 1662 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1664. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1662 may communicate using multiple standards or radios for communications at different range. For example, the IoT device 1650 may communicate with close devices, e.g., within about 10 meters, using a local transceiver based on BLE, or another low power radio, to save power. More distant mesh devices 1664, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1666 may be included to communicate with devices or services in the cloud 1600 via local or wide area network protocols. The wireless network transceiver 1666 may be a LPWA transceiver that follows the IEEE 802.15.4, or IEEE 802.15.4g standards, among others. The IoT device 1650 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1662 and wireless network transceiver 1666, as described herein. For example, the radio transceivers 1662 and 1666 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1662 and 1666 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1666, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1668 may be included to provide a wired communication to the cloud 1600 or to other devices, such as the mesh devices 1664. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1668 may be included to allow connect to a second network, for example, a NIC 1668 providing communications to the cloud over Ethernet, and a second NIC 1668 providing communications to other devices over another type of network.

The interconnect 1656 may couple the processor 1652 to an external interface 1670 that is used to connect external devices or subsystems. The external devices may include sensors 1672, such as accelerometers, level sensors, flow sensors, optical light sensors, camera sensors, temperature sensors, a global positioning system (GPS) sensors, pressure sensors, barometric pressure sensors, and the like. The external interface 1670 further may be used to connect the IoT device 1650 to actuators 1674, such as power switches, valve actuators, an audible sound generator, a visual warning device, and the like.

In some optional examples, various input/output (I/O) devices may be present within, or connected to, the IoT device 1650. For example, a display or other output device 1684 may be included to show information, such as sensor readings or actuator position. An input device 1686, such as a touch screen or keypad may be included to accept input. An output device 1686 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1650.

A battery 1676 may power the IoT device 1650, although in examples in which the IoT device 1650 is mounted in a fixed location, it may have a power supply coupled to an electrical grid. The battery 1676 may be a lithium ion battery, or a metal-air battery, such as a zinc-air battery, an aluminum-air battery, a lithium-air battery, and the like.

A battery monitor/charger 1678 may be included in the IoT device 1650 to track the state of charge (SoCh) of the battery 1676. The battery monitor/charger 1678 may be used to monitor other parameters of the battery 1676 to provide failure predictions, such as the state of health (SoH) and the state of function (SoF) of the battery 1676. The battery monitor/charger 1678 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1678 may communicate the information on the battery 1676 to the processor 1652 over the interconnect 1656. The battery monitor/charger 1678 may also include an analog-to-digital (ADC) convertor that allows the processor 1652 to directly monitor the voltage of the battery 1676 or the current flow from the battery 1676. The battery parameters may be used to determine actions that the IoT device 1650 may perform, such as transmission frequency, mesh network operation, sensing frequency, and the like.

A power block 1680, or other power supply coupled to a grid, may be coupled with the battery monitor/charger 1678 to charge the battery 1676. In some examples, the power block 1680 may be replaced with a wireless power receiver to obtain the power wirelessly, for example, through a loop antenna in the IoT device 1650. A wireless battery charging circuit, such as an LTC4020 chip from Linear Technologies of Milpitas, CA, among others, may be included in the battery monitor/charger 1678. The specific charging circuits chosen depend on the size of the battery 1676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1658 may include instructions 1682 in the form of software, firmware, or hardware commands to implement the techniques described herein. Although such instructions 1682 are shown as code blocks included in the memory 1654 and the storage 1658, it may be understood that any of the code blocks may be replaced with hardwired circuits, for example, built into an application specific integrated circuit (ASIC).

In an example, the instructions 1682 provided via the memory 1654, the storage 1658, or the processor 1652 may be embodied as a non-transitory, machine readable medium 1660 including code to direct the processor 1652 to perform electronic operations in the IoT device 1650. The processor 1652 may access the non-transitory, machine readable medium 1660 over the interconnect 1656. For instance, the non-transitory, machine readable medium 1660 may be embodied by devices described for the storage 1658 of FIG. 16 or may include specific storage units such as optical disks, flash drives, or any number of other hardware devices. The non-transitory, machine readable medium 1660 may include instructions to direct the processor 1652 to perform a specific sequence or flow of actions, for example, as described with respect to the flowchart(s) and block diagram(s) of operations and functionality depicted above.

Also in a specific example, the instructions 1688 on the processor 1652 (separately, or in combination with the instructions 1688 of the machine readable medium 1660) may configure execution or operation of a trusted execution environment (TEE) 1690. In an example, the TEE 1690 operates as a protected area accessible to the processor 1652 for secure execution of instructions and secure access to data. Various implementations of the TEE 1690, and an accompanying secure area in the processor 1652 or the memory 1654 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1650 through the TEE 1690 and the processor 1652.

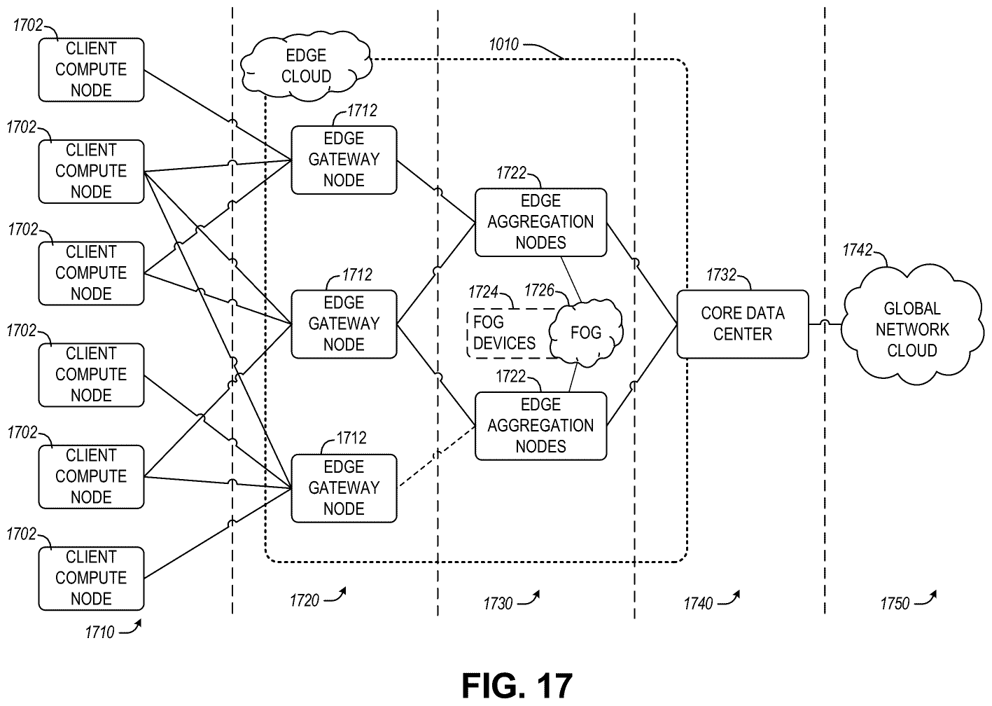

At a more generic level, an Edge computing system may be described to encompass any number of deployments operating in an Edge cloud 1010, which provide coordination from client and distributed computing devices. FIG. 17 provides a further abstracted overview of layers of distributed compute deployed among an Edge computing environment for purposes of illustration.

FIG. 17 generically depicts an Edge computing system for providing Edge services and applications to multi-stakeholder entities, as distributed among one or more client compute nodes 1702, one or more Edge gateway nodes 1712, one or more Edge aggregation nodes 1722, one or more core data centers 1732, and a global network cloud 1742, as distributed across layers of the network. The implementation of the Edge computing system may be provided at or on behalf of a telecommunication service provider (“telco”, or “TSP”), internet-of-things service provider, cloud service provider (CSP), enterprise entity, or any other number of entities.

Each node or device of the Edge computing system is located at a particular layer corresponding to layers 1710, 1720, 1730, 1740, 1750. For example, the client compute nodes 1702 are each located at an endpoint layer 1710, while each of the Edge gateway nodes 1712 are located at an Edge devices layer 1720 (local level) of the Edge computing system. Additionally, each of the Edge aggregation nodes 1722 (and/or fog devices 1724, if arranged or operated with or among a fog networking configuration 1726) are located at a network access layer 1730 (an intermediate level). Fog computing (or “fogging”) generally refers to extensions of cloud computing to the Edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with Edge computing as discussed herein; many of the Edge computing aspects discussed herein are applicable to fog networks, fogging, and fog configurations. Further, aspects of the Edge computing systems discussed herein may be configured as a fog, or aspects of a fog may be integrated into an Edge computing architecture.

The core data center 1732 is located at a core network layer 1740 (e.g., a regional or geographically-central level), while the global network cloud 1742 is located at a cloud data center layer 1750 (e.g., a national or global layer). The use of “core” is provided as a term for a centralized network location—deeper in the network—which is accessible by multiple Edge nodes or components; however, a “core” does not necessarily designate the “center” or the deepest location of the network. Accordingly, the core data center 1732 may be located within, at, or near the Edge cloud 1010.

Although an illustrative number of client compute nodes 1702, Edge gateway nodes 1712, Edge aggregation nodes 1722, core data centers 1732, global network clouds 1742 are shown in FIG. 17, it should be appreciated that the Edge computing system may include more or fewer devices or systems at each layer. Additionally, as shown in FIG. 17, the number of components of each layer 1710, 1720, 1730, 1740, 1750 generally increases at each lower level (i.e., when moving closer to endpoints). As such, one Edge gateway node 1712 may service multiple client compute nodes 1702, and one Edge aggregation node 1722 may service multiple Edge gateway nodes 1712.

Consistent with the examples provided herein, each client compute node 1702 may be embodied as any type of end point component, device, appliance, or “thing” capable of communicating as a producer or consumer of data. Further, the label “node” or “device” as used in the Edge computing system 1700 does not necessarily mean that such node or device operates in a client or agent/minion/follower role; rather, any of the nodes or devices in the Edge computing system 1700 refer to individual entities, nodes, or subsystems which include discrete or connected hardware or software configurations to facilitate or use the Edge cloud 1010.

As such, the Edge cloud 1010 is formed from network components and functional features operated by and within the Edge gateway nodes 1712 and the Edge aggregation nodes 1722 of layers 1720, 1730, respectively. The Edge cloud 1010 may be embodied as any type of network that provides Edge computing and/or storage resources which are proximately located to radio access network (RAN) capable endpoint devices (e.g., mobile computing devices, IoT devices, smart devices, etc.), which are shown in FIG. 17 as the client compute nodes 1702. In other words, the Edge cloud 1010 may be envisioned as an “Edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the Edge cloud 1010 may form a portion of or otherwise provide an ingress point into or across a fog networking configuration 1726 (e.g., a network of fog devices 1724, not shown in detail), which may be embodied as a system-level horizontal and distributed architecture that distributes resources and services to perform a specific function. For instance, a coordinated and distributed network of fog devices 1724 may perform computing, storage, control, or networking aspects in the context of an IoT system arrangement. Other networked, aggregated, and distributed functions may exist in the Edge cloud 1010 between the cloud data center layer 1750 and the client endpoints (e.g., client compute nodes 1702). Some of these are discussed in the following sections in the context of network functions or service virtualization, including the use of virtual Edges and virtual services which are orchestrated for multiple stakeholders.

The Edge gateway nodes 1712 and the Edge aggregation nodes 1722 cooperate to provide various Edge services and security to the client compute nodes 1702. Furthermore, because each client compute node 1702 may be stationary or mobile, each Edge gateway node 1712 may cooperate with other Edge gateway devices to propagate presently provided Edge services and security as the corresponding client compute node 1702 moves about a region. To do so, each of the Edge gateway nodes 1712 and/or Edge aggregation nodes 1722 may support multiple tenancy and multiple stakeholder configurations, in which services from (or hosted for) multiple service providers and multiple consumers may be supported and coordinated across a single or multiple compute devices.

### Mobility and Multi-Access Edge Computing

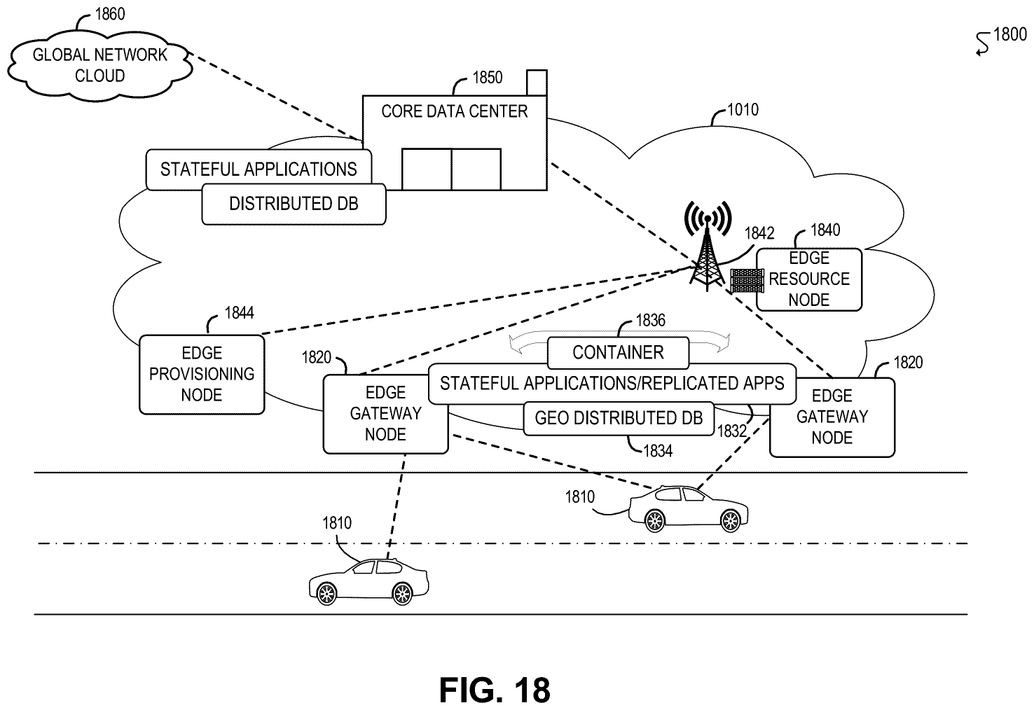

It should be appreciated that the Edge computing systems and arrangements discussed herein may be applicable in various solutions, services, and/or use cases involving mobility. As an example, FIG. 18 shows a simplified vehicle compute and communication use case involving mobile access to applications in an Edge computing system 1800 that implements an Edge cloud 1010. In this use case, respective client compute nodes 1810 may be embodied as in-vehicle compute systems (e.g., in-vehicle navigation and/or infotainment systems) located in corresponding vehicles which communicate with the Edge gateway nodes 1820 during traversal of a roadway. For instance, the Edge gateway nodes 1820 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 1810 and a particular Edge gateway device 1820 may propagate so as to maintain a consistent connection and context for the client compute node 1810. Likewise, mobile Edge nodes may aggregate at the high priority services or according to the throughput or latency resolution requirements for the underlying service(s) (e.g., in the case of drones). The respective Edge gateway devices 1820 include an amount of processing and storage capabilities and, as such, some processing and/or storage of data for the client compute nodes 1810 may be performed on one or more of the Edge gateway devices 1820.

The Edge gateway devices 1820 may communicate with one or more Edge resource nodes 1840, which are illustratively embodied as compute servers, appliances or components located at or in a communication base station 1842 (e.g., a base station of a cellular network). As discussed above, the respective Edge resource nodes 1840 include an amount of processing and storage capabilities and, as such, some processing and/or storage of data for the client compute nodes 1810 may be performed on the Edge resource node 1840. For example, the processing of data that is less urgent or important may be performed by the Edge resource node 1840, while the processing of data that is of a higher urgency or importance may be performed by the Edge gateway devices 1820 (depending on, for example, the capabilities of each component, or information in the request indicating urgency or importance). Based on data access, data location or latency, work may continue on Edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The Edge resource node(s) 1840 also communicate with the core data center 1850, which may include compute servers, appliances, and/or other components located in a central location (e.g., a central office of a cellular communication network). The core data center 1850 may provide a gateway to the global network cloud 1860 (e.g., the Internet) for the Edge cloud 1010 operations formed by the Edge resource node(s) 1840 and the Edge gateway devices 1820. Additionally, in some examples, the core data center 1850 may include an amount of processing and storage capabilities and, as such, some processing and/or storage of data for the client compute devices may be performed on the core data center 1850 (e.g., processing of low urgency or importance, or high complexity).

The Edge gateway nodes 1820 or the Edge resource nodes 1840 may offer the use of stateful applications 1832 and a geographic distributed database 1834. Although the applications 1832 and database 1834 are illustrated as being horizontally distributed at a layer of the Edge cloud 1010, it will be understood that resources, services, or other components of the application may be vertically distributed throughout the Edge cloud (including, part of the application executed at the client compute node 1810, other parts at the Edge gateway nodes 1820 or the Edge resource nodes 1840, etc.). Additionally, as stated previously, there can be peer relationships at any level to meet service objectives and obligations. Further, the data for a specific client or application can move from Edge to Edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 1836 (or pod of containers) may be flexibly migrated from an Edge node 1820 to other Edge nodes (e.g., 1820, C140, etc.) such that the container with an application and workload does not need to be reconstituted, re-compiled, re-interpreted in order for migration to work. However, in such settings, there may be some remedial or “swizzling” translation operations applied. For example, the physical hardware at node 1840 may differ from Edge gateway node 1820 and therefore, the hardware abstraction layer (HAL) that makes up the bottom Edge of the container will be re-mapped to the physical layer of the target Edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 18 may utilize various types of mobile Edge nodes, such as an Edge node hosted in a vehicle (e.g., a car, truck, tram, train, etc.) or other mobile unit, as the Edge node will move to other geographic locations along the platform hosting it. With vehicle-to-vehicle communications, individual vehicles may even act as network Edge nodes for other cars, (e.g., to perform caching, reporting, data aggregation, etc.). Thus, it will be understood that the application components provided in various Edge nodes may be distributed in static or mobile settings, including coordination between some functions or operations at individual endpoint devices or the Edge gateway nodes 1820, some others at the Edge resource node 1840, and others in the core data center 1850 or global network cloud 1860.

In further configurations, the Edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an Edge node or data center. A trigger such as, for example, a service use case or an Edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the Edge computing system, various datacenter, Edge, and endpoint (including mobile) devices are used to “spin up” functions (e.g., activate and/or allocate function actions) that are scaled on demand. The function code gets executed on the physical infrastructure (e.g., Edge computing node) device and underlying virtualized containers. Finally, the function(s) is/are “spun down” (e.g., deactivated and/or deallocated) on the infrastructure in response to the execution being completed.

Further aspects of FaaS may enable deployment of Edge functions in a service fashion, including a support of respective functions that support Edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The Edge computing system 1800 can include or be in communication with an Edge provisioning node 1844. The Edge provisioning node 1844 can distribute software such as the example machine (e.g., computer) readable instructions 2182 of FIG. 21B, to various receiving parties for implementing any of the methods described herein. The example Edge provisioning node 1844 may be implemented by any computer server, home server, content delivery network, virtual server, software distribution system, central facility, storage device, storage disk, storage node, data facility, cloud service, etc., capable of storing and/or transmitting software instructions (e.g., code, scripts, executable binaries, containers, packages, compressed files, and/or derivatives thereof) to other computing devices. Component(s) of the example Edge provisioning node 1844 may be located in a cloud, in a local area network, in an Edge network, in a wide area network, on the Internet, and/or any other location communicatively coupled with the receiving party(ies). The receiving parties may be customers, clients, associates, users, etc. of the entity owning and/or operating the Edge provisioning node 1844. For example, the entity that owns and/or operates the Edge provisioning node 1844 may be a developer, a seller, and/or a licensor (or a customer and/or consumer thereof) of software instructions such as the example computer readable instructions 2182 of FIG. 21B. The receiving parties may be consumers, service providers, users, retailers, OEMs, etc., who purchase and/or license the software instructions for use and/or re-sale and/or sub-licensing.

In an example, Edge provisioning node 1844 includes one or more servers and one or more storage devices/disks. The storage devices and/or storage disks host computer readable instructions such as the example computer readable instructions 2182 of FIG. 21B, as described below. Similarly to Edge gateway devices 1820 described above, the one or more servers of the Edge provisioning node 1844 are in communication with a base station 1842 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third-party payment entity. The servers enable purchasers and/or licensors to download the computer readable instructions 2182 from the Edge provisioning node 1844. For example, the software instructions, which may correspond to the example computer readable instructions 2182 of FIG. 21B, may be downloaded to the example processor platform's, which is to execute the computer readable instructions 2182 to implement the methods described herein.

In some examples, the processor platform(s) that execute the computer readable instructions 2182 can be physically located in different geographic locations, legal jurisdictions, etc. In some examples, one or more servers of the Edge provisioning node 1844 periodically offer, transmit, and/or force updates to the software instructions (e.g., the example computer readable instructions 2182 of FIG. 21B) to ensure improvements, patches, updates, etc. are distributed and applied to the software instructions implemented at the end user devices. In some examples, different components of the computer readable instructions 2182 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

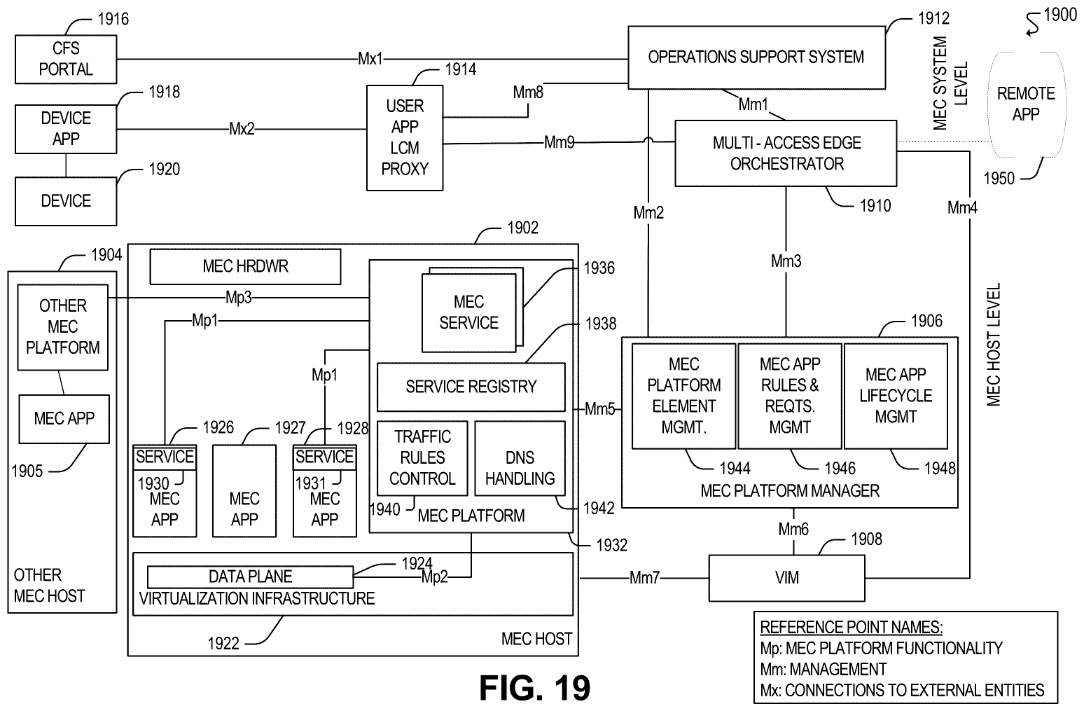

FIG. 19 illustrates a mobile Edge system reference architecture (or MEC architecture) 1900, such as is indicated by ETSI MEC specifications. FIG. 19 specifically illustrates a MEC architecture 1900 with MEC hosts 1902 and 1904 providing functionalities in accordance with the ETSI GS MEC-003 specification. In some aspects, enhancements to the MEC platform 1932 and the MEC platform manager 1906 may be used for providing specific computing functions within the MEC architecture 1900.

Referring to FIG. 19, the MEC network architecture 1900 can include MEC hosts 1902 and 1904, a virtualization infrastructure manager (VIM) 1908, an MEC platform manager 1906, an MEC orchestrator 1910, an operations support system 1912, a user app proxy 1914, a UE app 1918 running on UE 1920, and CFS portal 1916. The MEC host 1902 can include a MEC platform 1932 with filtering rules control component 1940, a DNS handling component 1942, a service registry 1938, and MEC services 1936. The MEC services 1936 can include at least one scheduler, which can be used to select resources for instantiating MEC apps (or NFVs) 1926, 1927, and 1928 upon virtualization infrastructure 1922. The MEC apps 1926 and 1928 can be configured to provide services 1930 and 1931, which can include processing network communications traffic of different types associated with one or more wireless connections (e.g., connections to one or more RAN or telecom-core network entities). The MEC app 1905 instantiated within MEC host 1904 can be similar to the MEC apps 1926-7728 instantiated within MEC host 1902. The virtualization infrastructure 1922 includes a data plane 1924 coupled to the MEC platform via an MP2 interface. Additional interfaces between various network entities of the MEC architecture 1900 are illustrated in FIG. 19.

The MEC platform manager 1906 can include MEC platform element management component 1944, MEC app rules and requirements management component 1946, and MEC app lifecycle management component 1948. The various entities within the MEC architecture 1900 can perform functionalities as disclosed by the ETSI GS MEC-003 specification. In some aspects, the remote application (or app) 1950 is configured to communicate with the MEC host 1902 (e.g., with the MEC apps 1926-1928) via the MEC orchestrator 1910 and the MEC platform manager 1906.

FIG. C3 illustrates an example MEC service architecture C300. MEC service architecture C300 includes the MEC service C305, a multi-access edge (ME) platform C310 (corresponding to MEC platform C232), and applications (Apps) 1 to N (where N is a number). As an example, the App 1 may be a content delivery network (CDN) app/service hosting 1 to n sessions (where n is a number that is the same or different than N), App 2 may be a gaming app/service which is shown as hosting two sessions, and App N may be some other app/service which is shown as a single instance (e.g., not hosting any sessions). Each App may be a distributed application that partitions tasks and/or workloads between resource providers (e.g., servers such as ME platform C310) and consumers (e.g., UEs, user apps instantiated by individual UEs, other servers/services, network functions, application functions, etc.). Each session represents an interactive information exchange between two or more elements, such as a client-side app and its corresponding server-side app, a user app instantiated by a UE and a MEC app instantiated by the ME platform C310, and/or the like. A session may begin when App execution is started or initiated and ends when the App exits or terminates execution. Additionally or alternatively, a session may begin when a connection is established and may end when the connection is terminated. Each App session may correspond to a currently running App instance. Additionally or alternatively, each session may correspond to a Protocol Data Unit (PDU) session or multi-access (MA) PDU session. A PDU session is an association between a UE and a DN that provides a PDU connectivity service, which is a service that provides for the exchange of PDUs between a UE and a Data Network. An MA PDU session is a PDU Session that provides a PDU connectivity service, which can use one access network at a time, or simultaneously a 3GPP access network and a non-3GPP access network. Furthermore, each session may be associated with a session identifier (ID) which is data the uniquely identifies a session, and each App (or App instance) may be associated with an App ID (or App instance ID) which is data the uniquely identifies an App (or App instance).

The MEC service C305 provides one or more MEC services C236 to MEC service consumers (e.g., Apps 1 to N). The MEC service C305 may optionally run as part of the platform (e.g., ME platform C310) or as an application (e.g., ME app). Different Apps 1 to N, whether managing a single instance or several sessions (e.g., CDN), may request specific service info per their requirements for the whole application instance or different requirements per session. The MEC service C305 may aggregate all the requests and act in a manner that will help optimize the BW usage and improve Quality of Experience (QoE) for applications.

The MEC service C305 provides a MEC service API that supports both queries and subscriptions (e.g., pub/sub mechanism) that are used over a Representational State Transfer (“REST” or “RESTful”) API or over alternative transports such as a message bus. For RESTful architectural style, the MEC APIs contain the HTTP protocol bindings for traffic management functionality.

Each Hypertext Transfer Protocol (HTTP) message is either a request or a response. A server listens on a connection for a request, parses each message received, interprets the message semantics in relation to the identified request target, and responds to that request with one or more response messages. A client constructs request messages to communicate specific intentions, examines received responses to see if the intentions were carried out, and determines how to interpret the results. The target of an HTTP request is called a “resource”. Additionally or alternatively, a “resource” is an object with a type, associated data, a set of methods that operate on it, and relationships to other resources if applicable. Each resource is identified by at least one Uniform Resource Identifier (URI), and a resource URI identifies at most one resource. Resources are acted upon by the RESTful API using HTTP methods (e.g., POST, GET, PUT, DELETE, etc.). With every HTTP method, one resource URI is passed in the request to address one particular resource. Operations on resources affect the state of the corresponding managed entities.

Considering that a resource could be anything, and that the uniform interface provided by HTTP is similar to a window through which one can observe and act upon such a thing only through the communication of messages to some independent actor on the other side, an abstraction is needed to represent (“take the place of”) the current or desired state of that thing in our communications. That abstraction is called a representation. For the purposes of HTTP, a “representation” is information that is intended to reflect a past, current, or desired state of a given resource, in a format that can be readily communicated via the protocol. A representation comprises a set of representation metadata and a potentially unbounded stream of representation data. Additionally or alternatively, a resource representation is a serialization of a resource state in a particular content format.

An origin server might be provided with, or be capable of generating, multiple representations that are each intended to reflect the current state of a target resource. In such cases, some algorithm is used by the origin server to select one of those representations as most applicable to a given request, usually based on content negotiation. This “selected representation” is used to provide the data and metadata for evaluating conditional requests constructing the payload for response messages (e.g., 200 OK, 304 Not Modified responses to GET, and the like). A resource representation is included in the payload body of an HTTP request or response message. Whether a representation is required or not allowed in a request depends on the HTTP method used (see e.g., Fielding et al., “Hypertext Transfer Protocol (HTTP/1.1): Semantics and Content”, IETF RFC 7231 (June 2014)).

The MEC API resource Universal Resource Indicators (URIs) are discussed in various ETSI MEC standards, such as those mentioned herein. The MTS API supports additional application-related error information to be provided in the HTTP response when an error occurs (see e.g., clause 6.15 of ETSI GS MEC 009 V2.1.1 (2019-01) (“[MEC009]”)). The syntax of each resource URI follows [MEC009], as well as Berners-Lee et al., “Uniform Resource Identifier (URI): Generic Syntax”, IETF Network Working Group, RFC 3986 (January 2005) and/or Nottingham, “URI Design and Ownership”, IETF RFC 8820 (June 2020). In the RESTful MEC service APIs, including the VIS API, the resource URI structure for each API has the following structure:
{apiRoot}/{apiName}/{apiVersion}/{apiSpecificSuffixes}

Here, “apiRoot” includes the scheme (“https”), host and optional port, and an optional prefix string. The “apiName” defines the name of the API (e.g., MTS API, RNI API, etc.). The “apiVersion” represents the version of the API, and the “apiSpecificSuffixes” define the tree of resource URIs in a particular API. The combination of “apiRoot”, “apiName” and “apiVersion” is called the root URI. The “apiRoot” is under control of the deployment, whereas the remaining parts of the URI are under control of the API specification. In the above root, “apiRoot” and “apiName” are discovered using the service registry (see e.g., service registry C238 in Figure C2). It includes the scheme (“http” or “https”), host and optional port, and an optional prefix string. For the a given MEC API, the “apiName” may be set to “mec” and “apiVersion” may be set to a suitable version number (e.g., “v1” for version 1). The MEC APIs support HTTP over TLS (also known as HTTPS). All resource URIs in the MEC API procedures are defined relative to the above root URI.

The JSON content format may also be supported. The JSON format is signaled by the content type “application/json”. The MTS API may use the OAuth 2.0 client credentials grant type with bearer tokens (see e.g., [MEC009]). The token endpoint can be discovered as part of the service availability query procedure defined in [MEC009]. The client credentials may be provisioned into the MEC app using known provisioning mechanisms.

### Computing Devices and Systems

In further examples, any of the compute nodes or devices discussed with reference to the present edge computing systems and environment may be fulfilled based on the components depicted in FIGS. 21A and 21B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 21A, an edge compute node 2100 includes a compute engine (also referred to herein as “compute circuitry”) 2102, an input/output (I/O) subsystem 2108, data storage 2110, a communication circuitry subsystem 2112, and, optionally, one or more peripheral devices 2114. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 2100 may be embodied as any type of engine, device, or collection of devices capable of performing various compute functions. In some examples, the compute node 2100 may be embodied as a single device such as an integrated circuit, an embedded system, a field-programmable gate array (FPGA), a system-on-a-chip (SOC), or other integrated system or device. In the illustrative example, the compute node 2100 includes or is embodied as a processor 2104 and a memory 2106. The processor 2104 may be embodied as any type of processor capable of performing the functions described herein (e.g., executing an application). For example, the processor 2104 may be embodied as a multi-core processor(s), a microcontroller, a processing unit, a specialized or special purpose processing unit, or other processor or processing/controlling circuit.

In some examples, the processor 2104 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 2104 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 2104 may work in coordination with each other to execute many types of operations and instructions within and on behalf of the compute node 2100.

The memory 2106 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 2106 may be integrated into the processor 2104. The memory 2106 may store various software and data used during operation such as one or more applications, data operated on by the application(s), libraries, and drivers.

The compute circuitry 2102 is communicatively coupled to other components of the compute node 2100 via the I/O subsystem 2108, which may be embodied as circuitry and/or components to facilitate input/output operations with the compute circuitry 2102 (e.g., with the processor 2104 and/or the main memory 2106) and other components of the compute circuitry 2102. For example, the I/O subsystem 2108 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2108 may form a portion of a system-on-a-chip (SoC) and be incorporated, along with one or more of the processor 2104, the memory 2106, and other components of the compute circuitry 2102, into the compute circuitry 2102.

The one or more illustrative data storage devices 2110 may be embodied as any type of devices configured for short-term or long-term storage of data such as, for example, memory devices and circuits, memory cards, hard disk drives, solid-state drives, or other data storage devices. Individual data storage devices 2110 may include a system partition that stores data and firmware code for the data storage device 2110. Individual data storage devices 2110 may also include one or more operating system partitions that store data files and executables for operating systems depending on, for example, the type of compute node 2100.

The communication circuitry 2112 may be embodied as any communication circuit, device, or collection thereof, capable of enabling communications over a network between the compute circuitry 2102 and another compute device (e.g., an edge gateway of an implementing edge computing system). The communication circuitry 2112 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 2112 includes a network interface controller (NIC) 2120, which may also be referred to as a host fabric interface (HFI). The NIC 2120 may be embodied as one or more add-in-boards, daughter cards, network interface cards, controller chips, chipsets, or other devices that may be used by the compute node 2100 to connect with another compute device (e.g., an edge gateway node). In some examples, the NIC 2120 may be embodied as part of a system-on-a-chip (SoC) that includes one or more processors, or included on a multichip package that also contains one or more processors. In some examples, the NIC 2120 may include a local processor (not shown) and/or a local memory (not shown) that are both local to the NIC 2120. In such examples, the local processor of the NIC 2120 may be capable of performing one or more of the functions of the compute circuitry 2102 described herein. Additionally, or alternatively, in such examples, the local memory of the NIC 2120 may be integrated into one or more components of the client compute node at the board level, socket level, chip level, and/or other levels.

Additionally, in some examples, a respective compute node 2100 may include one or more peripheral devices 2114. Such peripheral devices 2114 may include any type of peripheral device found in a compute device or server such as audio input devices, a display, other input/output devices, interface devices, and/or other peripheral devices, depending on the particular type of the compute node 2100. In further examples, the compute node 2100 may be embodied by a respective edge compute node (whether a client, gateway, or aggregation node) in an edge computing system or like forms of appliances, computers, subsystems, circuitry, or other components.

In a more detailed example, FIG. 21B illustrates a block diagram of an example of components that may be present in an edge computing node 2150 for implementing the techniques (e.g., operations, processes, methods, and methodologies) described herein. This edge computing node 2150 provides a closer view of the respective components of node 2100 when implemented as or as part of a computing device (e.g., as a mobile device, a base station, server, gateway, etc.). The edge computing node 2150 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 2150, or as components otherwise incorporated within a chassis of a larger system.

The edge computing device 2150 may include processing circuitry in the form of a processor 2152, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 2152 may be a part of a system on a chip (SoC) in which the processor 2152 and other components are formed into a single integrated circuit, or a single package, such as the Edison™ or Galileo™ SoC boards from Intel Corporation, Santa Clara, California. As an example, the processor 2152 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 2152 and accompanying circuitry may be provided in a single socket form factor, multiple socket form factor, or a variety of other formats, including in limited hardware configurations or configurations that include fewer than all elements shown in FIG. 21B.

The processor 2152 may communicate with a system memory 2154 over an interconnect 2156 (e.g., a bus). Any number of memory devices may be used to provide for a given amount of system memory. As examples, the memory 2154 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2158 may also couple to the processor 2152 via the interconnect 2156. In an example, the storage 2158 may be implemented via a solid-state disk drive (SSDD). Other devices that may be used for the storage 2158 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 2158 may be on-die memory or registers associated with the processor 2152. However, in some examples, the storage 2158 may be implemented using a micro hard disk drive (HDD). Further, any number of new technologies may be used for the storage 2158 in addition to, or instead of, the technologies described, such resistance change memories, phase change memories, holographic memories, or chemical memories, among others.

The components may communicate over the interconnect 2156. The interconnect 2156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2156 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 2156 may couple the processor 2152 to a transceiver 2166, for communications with the connected edge devices 2162. The transceiver 2166 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2162. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2166 (or multiple transceivers) may communicate using multiple standards or radios for communications at a different range. For example, the edge computing node 2150 may communicate with close devices, e.g., within about 10 meters, using a local transceiver based on Bluetooth Low Energy (BLE), or another low power radio, to save power. More distant connected edge devices 2162, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 2166 (e.g., a radio transceiver) may be included to communicate with devices or services in a cloud (e.g., an edge cloud 2195) via local or wide area network protocols. The wireless network transceiver 2166 may be a low-power wide-area (LPWA) transceiver that follows the IEEE 802.15.4, or IEEE 802.15.4g standards, among others. The edge computing node 2150 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2166, as described herein. For example, the transceiver 2166 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2166 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2168 may be included to provide a wired communication to nodes of the edge cloud 2195 or to other devices, such as the connected edge devices 2162 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 2168 may be included to enable connecting to a second network, for example, a first NIC 2168 providing communications to the cloud over Ethernet, and a second NIC 2168 providing communications to other devices over another type of network.

Given the variety of types of applicable communications from the device to another component or network, applicable communications circuitry used by the device may include or be embodied by any one or more of components 2164, 2166, 2168, or 2170. Accordingly, in various examples, applicable means for communicating (e.g., receiving, transmitting, etc.) may be embodied by such communications circuitry.

The edge computing node 2150 may include or be coupled to acceleration circuitry 2164, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 2156 may couple the processor 2152 to a sensor hub or external interface 2170 that is used to connect additional devices or subsystems. The devices may include sensors 2172, such as accelerometers, level sensors, flow sensors, optical light sensors, camera sensors, temperature sensors, global navigation system (e.g., GPS) sensors, pressure sensors, barometric pressure sensors, and the like. The hub or interface 2170 further may be used to connect the edge computing node 2150 to actuators 2174, such as power switches, valve actuators, an audible sound generator, a visual warning device, and the like.

In some optional examples, various input/output (I/O) devices may be present within or connected to, the edge computing node 2150. For example, a display or other output device 2184 may be included to show information, such as sensor readings or actuator position. An input device 2186, such as a touch screen or keypad may be included to accept input. An output device 2184 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 2150. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2176 may power the edge computing node 2150, although, in examples in which the edge computing node 2150 is mounted in a fixed location, it may have a power supply coupled to an electrical grid, or the battery may be used as a backup or for temporary capabilities. The battery 2176 may be a lithium ion battery, or a metal-air battery, such as a zinc-air battery, an aluminum-air battery, a lithium-air battery, and the like.

A battery monitor/charger 2178 may be included in the edge computing node 2150 to track the state of charge (SoCh) of the battery 2176, if included. The battery monitor/charger 2178 may be used to monitor other parameters of the battery 2176 to provide failure predictions, such as the state of health (SoH) and the state of function (SoF) of the battery 2176. The battery monitor/charger 2178 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2178 may communicate the information on the battery 2176 to the processor 2152 over the interconnect 2156. The battery monitor/charger 2178 may also include an analog-to-digital (ADC) converter that enables the processor 2152 to directly monitor the voltage of the battery 2176 or the current flow from the battery 2176. The battery parameters may be used to determine actions that the edge computing node 2150 may perform, such as transmission frequency, mesh network operation, sensing frequency, and the like.

A power block 2180, or other power supply coupled to a grid, may be coupled with the battery monitor/charger 2178 to charge the battery 2176. In some examples, the power block 2180 may be replaced with a wireless power receiver to obtain the power wirelessly, for example, through a loop antenna in the edge computing node 2150. A wireless battery charging circuit, such as an LTC4020 chip from Linear Technologies of Milpitas, California, among others, may be included in the battery monitor/charger 2178. The specific charging circuits may be selected based on the size of the battery 2176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2158 may include instructions 2182 in the form of software, firmware, or hardware commands to implement the techniques described herein. Although such instructions 2182 are shown as code blocks included in the memory 2154 and the storage 2158, it may be understood that any of the code blocks may be replaced with hardwired circuits, for example, built into an application specific integrated circuit (ASIC).

In an example, the instructions 2182 provided via the memory 2154, the storage 2158, or the processor 2152 may be embodied as a non-transitory, machine-readable medium 2160 including code to direct the processor 2152 to perform electronic operations in the edge computing node 2150. The processor 2152 may access the non-transitory, machine-readable medium 2160 over the interconnect 2156. For instance, the non-transitory, machine-readable medium 2160 may be embodied by devices described for the storage 2158 or may include specific storage units such as optical disks, flash drives, or any number of other hardware devices. The non-transitory, machine-readable medium 2160 may include instructions to direct the processor 2152 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 2182 on the processor 2152 (separately, or in combination with the instructions 2182 of the machine readable medium 2160) may configure execution or operation of a trusted execution environment (TEE) 2190. In an example, the TEE 2190 operates as a protected area accessible to the processor 2152 for secure execution of instructions and secure access to data. Various implementations of the TEE 2190, and an accompanying secure area in the processor 2152 or the memory 2154 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 2150 through the TEE 2190 and the processor 2152.

### Machine-Readable Medium and Distributed Software Instructions

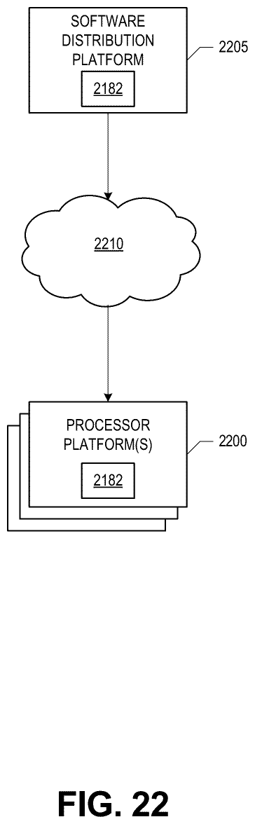

FIG. 22 illustrates an example software distribution platform 2205 to distribute software, such as the example computer readable instructions 2182 of FIG. 21B, to one or more devices, such as example processor platform(s) 2200 and/or example connected edge devices, gateways, and/or sensors described throughout this disclosure. The example software distribution platform 2205 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 2205). Example connected edge devices may operate in commercial and/or home automation environments. In some examples, a third party is a developer, a seller, and/or a licensor of software such as the example computer readable instructions 2182 of FIG. 21B. The third parties may be consumers, users, retailers, OEMs, etc. that purchase and/or license the software for use and/or re-sale and/or sub-licensing. In some examples, distributed software causes display of one or more user interfaces (Uls) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 22, the software distribution platform 2205 includes one or more servers and one or more storage devices. The storage devices store the computer readable instructions 2182. The one or more servers of the example software distribution platform 2205 are in communication with a network 2210, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2182 from the software distribution platform 2205. For example, the software, which may correspond to the example computer readable instructions described throughout this disclosure, may be downloaded to the example processor platform(s) 2200 (e.g., example connected edge devices), which is/are to execute the computer readable instructions 2182 to implement the functionality described throughout this disclosure. In some examples, one or more servers of the software distribution platform 2205 are communicatively connected to one or more security domains and/or security devices through which requests and transmissions of the example computer readable instructions 2182 must pass. In some examples, one or more servers of the software distribution platform 2205 periodically offer, transmit, and/or force updates to the software (e.g., the example computer readable instructions 2182 of FIG. 21B) to ensure improvements, patches, updates, etc. are distributed and applied to the software at the end user devices.

In the illustrated example of FIG. 22, the computer readable instructions 2182 are stored on storage devices of the software distribution platform 2205 in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions 2182 stored in the software distribution platform 2205 are in a first format when transmitted to the example processor platform(s) 2200. In some examples, the first format is an executable binary in which particular types of the processor platform(s) 2200 can execute. However, in some examples, the first format is uncompiled code that requires one or more preparation tasks to transform the first format to a second format to enable execution on the example processor platform(s) 2200. For instance, the receiving processor platform(s) 2200 may need to compile the computer readable instructions 2182 in the first format to generate executable code in a second format that is capable of being executed on the processor platform(s) 2200. In still other examples, the first format is interpreted code that, upon reaching the processor platform(s) 2200, is interpreted by an interpreter to facilitate execution of instructions.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a method of training an autoencoder neural network, comprising: determining a plurality of autoencoder design parameters for the autoencoder neural network, wherein the plurality of autoencoder design parameters comprise: an input image size for an input image to be processed by the autoencoder neural network, wherein the input image size is determined based on a resolution of training images in a training dataset and a size of one or more target features to be detected; a compression ratio for compression of the input image into a latent vector, wherein the compression ratio is determined based on an entropy of the training images; and a latent vector size for the latent vector, wherein the latent vector size is determined based on the compression ratio; training the autoencoder neural network based on the plurality of autoencoder design parameters and the training dataset; and saving the trained autoencoder neural network on a storage device.

Example 2 includes the method of Example 1, wherein training the autoencoder neural network based on the plurality of autoencoder design parameters and the training dataset comprises: determining that the trained autoencoder neural network fails to satisfy one or more performance requirements; adjusting a configuration of the autoencoder neural network; and retraining the autoencoder neural network based on the adjusted configuration.

Example 3 includes the method of Example 2, wherein adjusting the configuration the autoencoder neural network comprises: configuring the autoencoder neural network to perform noise removal, image imputation, or coarse dropout on the input image.

Example 4 includes the method of any of Examples 1-3, wherein training the autoencoder neural network based on the plurality of autoencoder design parameters and the training dataset comprises: identifying, based on the plurality of autoencoder design parameters, a plurality of autoencoder configurations to be evaluated; training a plurality of autoencoder neural networks based on the plurality of autoencoder configurations; evaluating a performance of the plurality of trained autoencoder neural networks; and selecting, from the plurality of trained autoencoder neural networks, the trained autoencoder neural network having a highest performance.

Example 5 includes the method of Example 4, wherein the plurality of autoencoder configurations comprise: one or more encoder configurations; and one or more decoder configurations.

Example 6 includes the method of any of Examples 1-5, wherein determining the plurality of autoencoder design parameters for the autoencoder neural network comprises: determining an optimal quantization parameter for compression of the input image into the latent vector, wherein the optimal quantization parameter is determined based on a peak signal-to-noise ratio, a bit rate, and a quantization parameter difference computed for the training images; and determining the compression ratio based on the optimal quantization parameter.

Example 7 includes the method of any of Examples 1-6, wherein determine the plurality of autoencoder design parameters for the autoencoder neural network comprises: computing, based on the latent vector size, a latent vector length and a downsample ratio.

Example 8 includes the method of any of Examples 1-7, wherein the one or more target features comprise one or more defects associated with an industrial process.

Example 9 includes the method of Example 8, wherein the input image size is proportional to a size of the one or more defects.

Example 10 includes the method of any of Examples 8-9, further comprising: deploying the trained autoencoder neural network, wherein the trained autoencoder neural network is deployed to detect the one or more defects in images captured by a camera during performance of the industrial process.

Example 11 includes the method of any of Examples 1-10, wherein the latent vector comprises a plurality of latent vectors, wherein a plurality of feature sets are to be extracted from the input image and compressed into the plurality of latent vectors.

Example 12 includes a method of anomaly detection, comprising: receiving, via interface circuitry, a frame captured by a camera; processing the frame through an autoencoder neural network, wherein processing the frame through the autoencoder neural network comprises: extracting a plurality of feature sets from the frame; encoding the plurality of feature sets into a plurality of latent vectors; decoding the plurality of latent vectors into a plurality of reconstructed feature sets; generating a reconstructed frame based on the plurality of reconstructed feature sets; and computing a reconstruction loss for the reconstructed frame relative to the frame; and detecting an anomaly in the frame based on the reconstruction loss.

Example 13 includes the method of Example 12, wherein the autoencoder neural network comprises a convolutional neural network (CNN), wherein the CNN is trained to extract the plurality of feature sets from the frame.

Example 14 includes the method of any of Examples 12-13, wherein the autoencoder neural network comprises an encoder and a plurality of decoders, wherein: the encoder is trained to encode the plurality of feature sets into the plurality of latent vectors; and the plurality of decoders are trained to decode the plurality of latent vectors into the plurality of reconstructed feature sets.

Example 15 includes the method of Example 14, further comprising: determining that the anomaly detected in the frame is a false positive; and retraining a subset of the plurality of decoders using the frame as training data.

Example 16 includes the method of any of Examples 12-15, wherein: the frame is captured during performance of an industrial process; and the anomaly is associated with performance of the industrial process.

Example 17 includes the method of Example 16, wherein: the industrial process is performed by a robot; and the method further comprises: sending, via the interface circuitry, a command to cause the robot to perform an action based on occurrence of the anomaly.

Example 18 includes the method of Example 17, wherein the action comprises: aborting the industrial process; or repeating at least a portion of the industrial process.

Example 19 includes the method of any of Examples 16-18, wherein the industrial process comprises a fabrication process.

Example 20 includes the method of Example 19, wherein the fabrication process comprises a weld operation.

Example 21 includes a method of unsupervised training for an autoencoder neural network, comprising: receiving a data point in a training dataset, wherein the training dataset comprises a plurality of data points; forward propagating the data point through the autoencoder neural network, wherein forward propagating the data point through the autoencoder neural network comprises: encoding the data point into a latent vector; decoding the latent vector into a reconstructed data point; and computing a reconstruction loss for the reconstructed data point relative to the data point; determining, based on the reconstruction loss, whether the data point is an outlier; upon determining that the data point is not an outlier, backward propagating the data point through the autoencoder neural network, wherein one or more weights of the autoencoder neural network are adjusted based on backward propagation of the data point; and upon determining that the data point is an outlier, skipping backward propagation of the data point through the autoencoder neural network.

Example 22 includes the method of Example 21, wherein determining, based on the reconstruction loss, whether the data point is an outlier comprises: determining, based on the reconstruction loss of the data point compared to reconstruction losses computed for other data points in the training dataset, that the data point is an outlier.

Example 23 includes the method of any of Examples 21-22, wherein the method is performed for each data point in the training dataset.

Example 24 includes the method of any of Examples 21-23, wherein the plurality of data points comprise a plurality of images.

Example 25 includes the method of Example 24, further comprising: receiving, via interface circuitry, an image captured by a camera; processing the image through the autoencoder neural network, wherein processing the image through the autoencoder neural network comprises: encoding the image into a latent vector; decoding the latent vector into a reconstructed image; computing a reconstruction loss for the reconstructed image relative to the image; and detecting an anomaly in the image based on the reconstruction loss.

Example 26 includes the method of Example 25, wherein detecting the anomaly in the image based on the reconstruction loss comprises: determining that the reconstruction loss exceeds a threshold; and detecting the anomaly in the image based on the reconstruction loss exceeding the threshold.

Example 27 includes the method of Example 25, wherein detecting the anomaly in the image based on the reconstruction loss comprises: determining that the reconstruction loss is below a threshold; determining, based on a data distribution of the training dataset, that the image is an outlier; and detecting the anomaly in the image based on determining that the image is an outlier.

Example 28 includes the method of any of Examples 25-27, wherein: the image is captured during performance of an industrial process; and the anomaly is associated with performance of the industrial process.

Example 29 includes the method of Example 28, wherein: the industrial process is performed by a robot; and the method further comprises: sending, via the interface circuitry, a command to cause the robot to perform an action based on occurrence of the anomaly.

Example 30 includes the method of Example 29, wherein the action comprises: aborting the industrial process; or repeating at least a portion of the industrial process.

Example 31 includes the method of any of Examples 28-30, wherein the industrial process comprises a fabrication process.

Example 32 includes the method of Example 31, wherein the fabrication process comprises a weld operation.

Example 33 includes the method of any of Examples 1-32, wherein the method is performed by a smart camera.

Example 34 includes the method of any of Examples 1-32, wherein the method is performed by a robot.

Example 35 includes the method of any of Examples 1-32, wherein the method is performed by a tool or tool controller.

Example 36 includes the method of any of Examples 1-32, wherein the method is performed by a manufacturing equipment or machine.

Example 37 includes the method of any of Examples 1-32, wherein the method is performed by an industrial personal computer (PC).

Example 38 includes the method of any of Examples 1-32, wherein the method is performed by a fault detection system.

Example 39 includes the method of any of Examples 1-32, wherein the method is performed by a vehicle or aircraft.

Example 40 includes the method of any of Examples 1-32, wherein the method is performed by an edge computing system, edge server, or edge node.

Example 41 includes the method of any of Examples 1-32, wherein the method is performed by an edge cloud system, edge cloud server, or edge cloud node.

Example 42 includes the method of any of Examples 1-32, wherein the method is performed by a multi-access edge computing (MEC) system, MEC server, or MEC node.

Example 43 includes the method of any of Examples 1-32, wherein the method is performed by a cloud computing system, cloud server, or cloud node.

Example 44 includes the method of any of Examples 1-32, wherein the method is performed by a server, server device, or server node.

Example 45 includes the method of any of Examples 1-32, wherein the method is performed by a client, client device, or client node.

Example 46 includes the method of any of Examples 1-32, wherein the method is performed by a gateway, gateway device, or gateway node.

Example 47 includes the method of any of Examples 1-32, wherein the method is performed by a mobile device or user equipment device.

Example 48 includes a smart camera comprising circuitry to implement the method of any of Examples 1-32.

Example 49 includes a robot comprising circuitry to implement the method of any of Examples 1-32.

Example 50 includes a tool or tool controller comprising circuitry to implement the method of any of Examples 1-32.

Example 51 includes a manufacturing equipment or machine comprising circuitry to implement the method of any of Examples 1-32.

Example 52 includes an industrial personal computer (PC) comprising circuitry to implement the method of any of Examples 1-32.

Example 53 includes a fault detection system comprising circuitry to implement the method of any of Examples 1-32.

Example 54 includes a vehicle or aircraft comprising circuitry to implement the method of any of Examples 1-32.

Example 55 includes an edge computing system, edge server, or edge node comprising circuitry to implement the method of any of Examples 1-32.

Example 56 includes an edge cloud system, edge cloud server, or edge cloud node comprising circuitry to implement the method of any of Examples 1-32.

Example 57 includes a multi-access edge computing (MEC) system, MEC server, or MEC node comprising circuitry to implement the method of any of Examples 1-32.

Example 58 includes a cloud computing system, cloud server, or cloud node comprising circuitry to implement the method of any of Examples 1-32.

Example 59 includes a server, server device, or server node comprising circuitry to implement the method of any of Examples 1-32.

Example 60 includes a client, client device, or client node comprising circuitry to implement the method of any of Examples 1-32.

Example 61 includes a client computing device or end user device comprising circuitry to implement the method of any of Examples 1-32.

Example 62 includes a gateway, gateway device, or gateway node comprising circuitry to implement the method of any of Examples 1-32.

Example 63 includes a mobile device or user equipment device comprising circuitry to implement the method of any of Examples 1-32.

Example 64 includes an apparatus comprising means to implement the method of any of Examples 1-32.

Example 65 includes an apparatus comprising logic, modules, or circuitry to implement the method of any of Examples 1-32.

Example 66 includes an apparatus comprising processing circuitry, interface circuitry, and storage circuitry to implement the method of any of Examples 1-32.

Example 67 includes an apparatus comprising: one or more processors and one or more computer-readable media comprising instructions that, when executed by the one or more processors, cause the one or more processors to implement the method of any of Examples 1-32.

Example 68 includes a computing device comprising processing circuitry, interface circuitry, and storage circuitry to implement the method of any of Examples 1-32.

Example 69 includes one or more non-transitory computer-readable media comprising instructions to cause an electronic device, upon execution of the instructions by one or more processors of the electronic device, to implement the method of any of Examples 1-32.

Example 70 includes a computer program comprising instructions, wherein execution of the program by a processing element is to cause the processing element to implement the method of any of Examples 1-32.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

1-70. (canceled)

71. A computing device, comprising:
a storage device to store a training dataset, wherein the training dataset comprises a plurality of training images; and
processing circuitry to:
determine a plurality of autoencoder design parameters for an autoencoder neural network, wherein the plurality of autoencoder design parameters comprise:
an input image size for an input image to be processed by the autoencoder neural network, wherein the input image size is determined based on a resolution of the training images and a size of one or more target features to be detected;
a compression ratio for compression of the input image into a latent vector, wherein the compression ratio is determined based on an entropy of the training images; and
a latent vector size for the latent vector, wherein the latent vector size is determined based on the compression ratio;
train the autoencoder neural network based on the plurality of autoencoder design parameters and the training dataset; and
save the trained autoencoder neural network on the storage device.

72. The computing device of claim 71, wherein the processing circuitry to train the autoencoder neural network based on the plurality of autoencoder design parameters and the training dataset is further to:
determine that the trained autoencoder neural network fails to satisfy one or more performance requirements;
adjust a configuration of the autoencoder neural network; and
retrain the autoencoder neural network based on the adjusted configuration.

73. The computing device of claim 72, wherein the processing circuitry to adjust the configuration the autoencoder neural network is further to:
configure the autoencoder neural network to perform noise removal, image imputation, or coarse dropout on the input image.

74. The computing device of claim 71, wherein the processing circuitry to train the autoencoder neural network based on the plurality of autoencoder design parameters and the training dataset is further to:
identify, based on the plurality of autoencoder design parameters, a plurality of autoencoder configurations to be evaluated;
train a plurality of autoencoder neural networks based on the plurality of autoencoder configurations;
evaluate a performance of the plurality of trained autoencoder neural networks; and
select, from the plurality of trained autoencoder neural networks, the trained autoencoder neural network having a highest performance.

75. The computing device of claim 74, wherein the plurality of autoencoder configurations comprise:
one or more encoder configurations; and
one or more decoder configurations.

76. The computing device of claim 71, wherein the processing circuitry to determine the plurality of autoencoder design parameters for the autoencoder neural network is further to:
determine an optimal quantization parameter for compression of the input image into the latent vector, wherein the optimal quantization parameter is determined based on a peak signal-to-noise ratio, a bit rate, and a quantization parameter difference computed for the training images; and
determine the compression ratio based on the optimal quantization parameter.

77. The computing device of claim 71, wherein the processing circuitry to determine the plurality of autoencoder design parameters for the autoencoder neural network is further to:
compute, based on the latent vector size, a latent vector length and a downsample ratio.

78. The computing device of claim 71, wherein the one or more target features comprise one or more defects associated with an industrial process.

79. The computing device of claim 78, wherein the input image size is proportional to a size of the one or more defects.

80. The computing device of claim 78, wherein the processing circuitry is further to:
deploy the trained autoencoder neural network, wherein the trained autoencoder neural network is deployed to detect the one or more defects in images captured by a camera during performance of the industrial process.

81. At least one non-transitory machine-readable storage medium having instructions stored thereon, wherein the instructions, when executed on processing circuitry, cause the processing circuitry to:
determine a plurality of autoencoder design parameters for an autoencoder neural network, wherein the plurality of autoencoder design parameters comprise:
an input image size for an input image to be processed by the autoencoder neural network, wherein the input image size is determined based on a resolution of training images in a training dataset and a size of one or more target features to be detected;
a compression ratio for compression of the input image into a latent vector, wherein the compression ratio is determined based on an entropy of the training images; and
a latent vector size for the latent vector, wherein the latent vector size is determined based on the compression ratio;
train the autoencoder neural network based on the plurality of autoencoder design parameters and the training dataset; and
save the trained autoencoder neural network on a storage device.

82. The storage medium of claim 81, wherein the instructions that cause the processing circuitry to train the autoencoder neural network based on the plurality of autoencoder design parameters and the training dataset further cause the processing circuitry to:
determine that the trained autoencoder neural network fails to satisfy one or more performance requirements;
adjust a configuration of the autoencoder neural network; and
retrain the autoencoder neural network based on the adjusted configuration.

83. The storage medium of claim 82, wherein the instructions that cause the processing circuitry to adjust the configuration the autoencoder neural network further cause the processing circuitry to:
configure the autoencoder neural network to perform noise removal, image imputation, or coarse dropout on the input image.

84. The storage medium of claim 81, wherein the instructions that cause the processing circuitry to train the autoencoder neural network based on the plurality of autoencoder design parameters and the training dataset further cause the processing circuitry to:
identify, based on the plurality of autoencoder design parameters, a plurality of autoencoder configurations to be evaluated;
train a plurality of autoencoder neural networks based on the plurality of autoencoder configurations;
evaluate a performance of the plurality of trained autoencoder neural networks; and
select, from the plurality of trained autoencoder neural networks, the trained autoencoder neural network having a highest performance.

85. The storage medium of claim 84, wherein the plurality of autoencoder configurations comprise:
one or more encoder configurations; and
one or more decoder configurations.

86. The storage medium of claim 81, wherein the instructions that cause the processing circuitry to determine the plurality of autoencoder design parameters for the autoencoder neural network further cause the processing circuitry to:
determine an optimal quantization parameter for compression of the input image into the latent vector, wherein the optimal quantization parameter is determined based on a peak signal-to-noise ratio, a bit rate, and a quantization parameter difference computed for the training images; and
determine the compression ratio based on the optimal quantization parameter.

87. The storage medium of claim 81, wherein the instructions that cause the processing circuitry to determine the plurality of autoencoder design parameters for the autoencoder neural network further cause the processing circuitry to:
compute, based on the latent vector size, a latent vector length and a downsample ratio.

88. The storage medium of claim 81, wherein the one or more target features comprise one or more defects associated with an industrial process.

89. The storage medium of claim 88, wherein the input image size is proportional to a size of the one or more defects.

90. The storage medium of claim 88, wherein the instructions further cause the processing circuitry to:
deploy the trained autoencoder neural network, wherein the trained autoencoder neural network is deployed to detect the one or more defects in images captured by a camera during performance of the industrial process.

91. A method of training an autoencoder neural network, comprising:
determining a plurality of autoencoder design parameters for the autoencoder neural network, wherein the plurality of autoencoder design parameters comprise:
an input image size for an input image to be processed by the autoencoder neural network, wherein the input image size is determined based on a resolution of training images in a training dataset and a size of one or more target features to be detected;
a compression ratio for compression of the input image into a latent vector, wherein the compression ratio is determined based on an entropy of the training images; and
a latent vector size for the latent vector, wherein the latent vector size is determined based on the compression ratio;
training the autoencoder neural network based on the plurality of autoencoder design parameters and the training dataset; and
saving the trained autoencoder neural network on a storage device.

92. The method of claim 91, wherein training the autoencoder neural network based on the plurality of autoencoder design parameters and the training dataset comprises:
determining that the trained autoencoder neural network fails to satisfy one or more performance requirements;
adjusting a configuration of the autoencoder neural network; and
retraining the autoencoder neural network based on the adjusted configuration.

93. The method of claim 91, wherein training the autoencoder neural network based on the plurality of autoencoder design parameters and the training dataset comprises:
identifying, based on the plurality of autoencoder design parameters, a plurality of autoencoder configurations to be evaluated;
training a plurality of autoencoder neural networks based on the plurality of autoencoder configurations;
evaluating a performance of the plurality of trained autoencoder neural networks; and
selecting, from the plurality of trained autoencoder neural networks, the trained autoencoder neural network having a highest performance.

94. The method of claim 91, wherein the one or more target features comprise one or more defects associated with an industrial process.

95. The method of claim 94, further comprising:
deploying the trained autoencoder neural network, wherein the trained autoencoder neural network is deployed to detect the one or more defects in images captured by a camera during performance of the industrial process.
